(19) United States
(12) Patent Application Publication
(10) Pub. No.: US 2019/0276044 A1
(43) Pub. Date: Sep. 12, 2019

(54) USER INTERFACE APPARATUS FOR VEHICLE AND VEHICLE INCLUDING THE SAME

(71) Applicant: LG ELECTRONICS INC., Seoul (KR)

(72) Inventors: Hyeonju BAE, Seoul (KR); Duckgee PARK, Seoul (KR); Jonghwa YOON, Seoul (KR)

(73) Assignee: LG ELECTRONICS INC., Seoul (KR)

(21) Appl. No.: 16/348,833

(22) PCT Filed: Nov. 26, 2016
(86) PCT No.: PCT/KR2016/013743

§ 371 Date: May 9, 2019

(30) Foreign Application Priority Data
Nov. 9, 2016 (KR) 10-2016-0148974

(51) Int. Cl. B60W 50/08; G06F 3/0484; G05D 1/00; B60W 10/20; B60W 10/18; B60W 10/04; B60W 30/18

(52) U.S. Cl. CPC B60W 50/08; G06F 3/04847; G05D 1/0088; B60W 2050/007; B60W 10/18; B60W 10/04; B60W 30/18; B60W 10/20

(57) ABSTRACT

The present invention relates to a user interface apparatus for vehicle comprising: an output unit; a driver sensing unit; and a processor configured to determine a driving level of a driver, based on driver information acquired through the driver sensing unit, select a traveling function based on the driving level of the driver among a plurality of traveling functions, and control to output information on the selected traveling function through the output unit.

### TECHNICAL FIELD

The present invention relates to a user interface apparatus for vehicle, and a vehicle including the same.

### BACKGROUND ART

A vehicle is an apparatus that moves in a direction desired by a user riding therein. A representative example of a vehicle is an automobile. A variety of sensors and electronic devices are provided for convenience of a user who uses the vehicle. In particular, for driving convenience of user, an Advanced Driver Assistance System (ADAS) has been actively studied. In addition, development of autonomous vehicles has been vigorously accomplished.

The vehicles according to the related art provide a manual having the same content irrespective of the skill of the driver.

In particular, various functions of the Advanced Driver Assistance System and information on various functions of the autonomous vehicles are also provided in a booklet regardless of the skill of the driver.

The provision of information in this manner has a problem in that the driver may not accurately grasp the complex and various technologies applied to the vehicle, and may not appropriately utilize the technology.

### DISCLOSURE

### Technical Problem

The present invention has been made in view of the above problems, and it is an object of the present invention is to provide a user interface apparatus for vehicle that provides information on various traveling functions that may be implemented in a vehicle.

It is another object of the present invention to provide a vehicle including the user interface apparatus for vehicle.

The missions of the present invention are not limited to the above-mentioned missions, and other missions not mentioned may be clearly understood by those skilled in the art from the following description.

### Technical Solution

In an aspect, there is provided a user interface apparatus for vehicle including: an output unit; a driver sensing unit; and a processor configured to determine a driving level of a driver, based on driver information acquired through the driver sensing unit, select a traveling function based on the driving level of the driver among a plurality of traveling functions, and control to output information on the selected traveling function through the output unit.

The details of embodiments are included in the detailed description and drawings.

### Advantageous Effects

According to an embodiment of the present invention, there is one or more of the following effects.

First, it provides an appropriate traveling function for the driver, thereby enhancing user convenience.

Second, it provides information on the traveling functions implemented in the vehicle, and the traveling functions may be appropriately utilized as needed.

Third, it is possible to achieve a safe driving by implementing suitable traveling functions for a user.

The effects of the present invention are not limited to the effects mentioned above, and other effects not mentioned may be clearly understood by those skilled in the art from the description of the claims.

### DESCRIPTION OF DRAWINGS

FIG. 1 is a diagram illustrating the external appearance of a vehicle according to an embodiment of the present invention.

FIG. 2 is different angled views of the external appearance of a vehicle according to an embodiment of the present invention.

FIGS. 3 and 4 are diagrams illustrating the interior configuration of a vehicle according to an embodiment of the present invention.

FIGS. 5 and 6 are diagrams illustrating an object according to an embodiment of the present invention.

FIG. 7 is a block diagram illustrating a vehicle according to an embodiment of the present invention.

FIG. 8 is a block diagram illustrating a user interface apparatus for a vehicle according to an embodiment of the present invention.

FIG. 9 is a flowchart illustrating an operation of a user interface apparatus for a vehicle according to an embodiment of the present invention.

FIG. 10 is a diagram illustrating an operation of determining a driver's driving level based on driver information according to an embodiment of the present invention.

FIG. 11 is a diagram illustrating an operation of acquiring traveling state information according to an embodiment of the present invention.

FIGS. 12A and 12B are diagrams illustrating examples of a traveling function selected based on a driving level, a driver type, or the traveling state information according to an embodiment of the present invention.

FIGS. 13A to 13C are diagrams illustrating the operation of a vehicle that outputs information on the traveling function and travels according to the traveling function according to an embodiment of the present invention.

FIGS. 14A and 14B are diagrams illustrating an operation of outputting a tutorial image according to an embodiment of the present invention.

FIGS. 15A to 15E are diagrams illustrating an operation of outputting a simulation image, according to an embodiment of the present invention.

FIG. 16 is a diagram illustrating an operation of outputting a plurality of step information set in the traveling function according to an embodiment of the present invention.

FIGS. 17A and 17B are diagrams illustrating an operation of outputting a traveling image according to an embodiment of the present invention.

FIGS. 18A to 18C are diagrams illustrating the operation of outputting information on the traveling function according to an embodiment of the present invention.

FIGS. 19A and 19B are diagrams illustrating the operation of setting a mission and achieving the mission according to an embodiment of the present invention.

FIGS. 20A and 20B are diagrams illustrating driver intervention according to an embodiment of the present invention.

FIGS. 21A to 21C are diagrams illustrating the operation of a user interface apparatus for a vehicle for correcting driving habit according to an embodiment of the present invention.

### MODE FOR INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present invention.

Although the terms “first,” “second,” etc., may be used herein to describe various components, these components should not be limited by these terms. These terms are only used to distinguish one component from another component. When a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise. In the present application, it will be further understood that the terms “comprises”, includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may include an automobile and a motorcycle. Hereinafter, a description will be given based on an automobile.

A vehicle as described in this specification may include all of an internal combustion engine vehicle including an engine as a power source, a hybrid vehicle including both an engine and an electric motor as a power source, and an electric vehicle including an electric motor as a power source.

In the following description, “the left side of the vehicle” refers to the left side in the traveling direction of the vehicle, and “the right side of the vehicle” refers to the right side in the traveling direction of the vehicle.

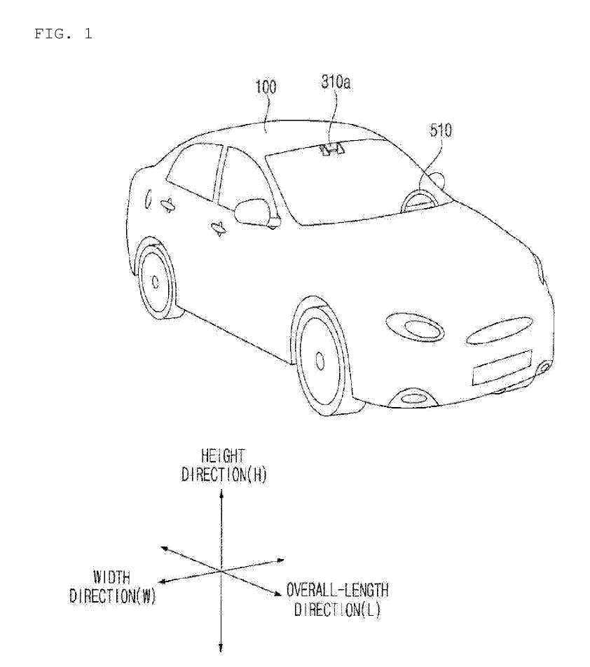

FIG. 1 is a diagram illustrating the external appearance of a vehicle according to an embodiment of the present invention.

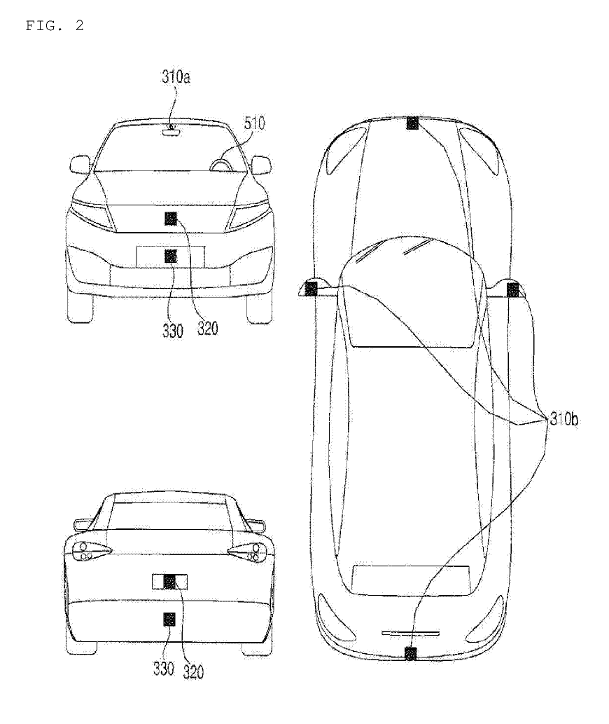

FIG. 2 is different angled views of the external appearance of a vehicle according to an embodiment of the present invention.

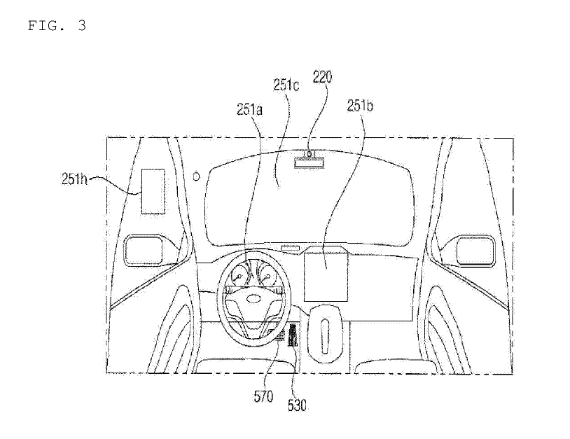

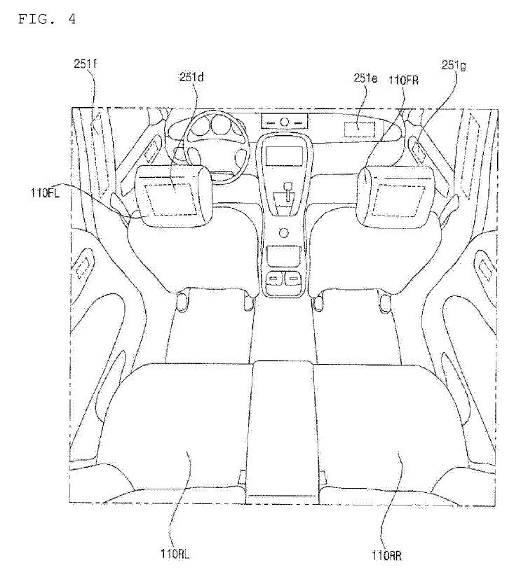

FIGS. 3 and 4 are diagrams illustrating the interior configuration of a vehicle according to an embodiment of the present invention.

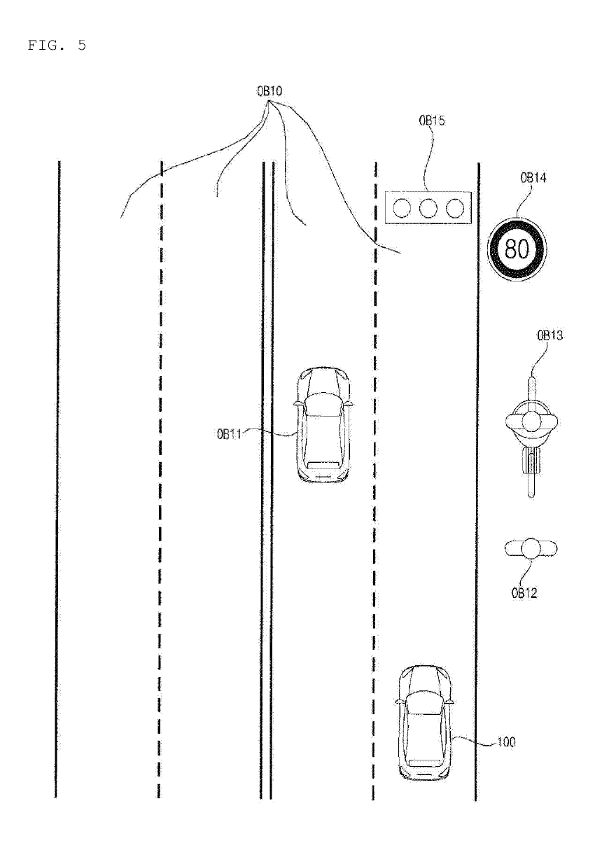

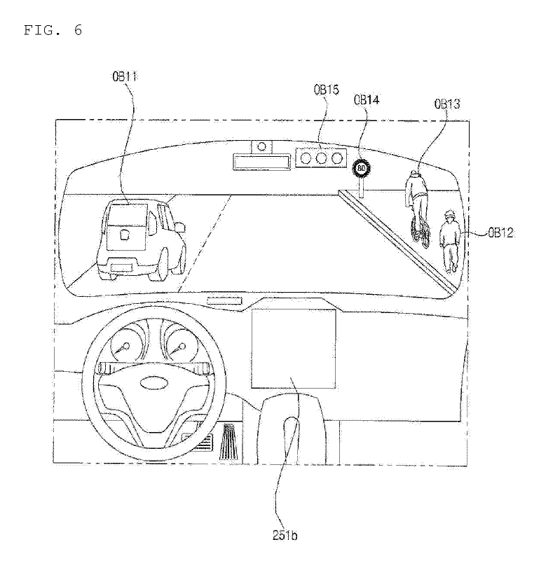

FIGS. 5 and 6 are diagrams illustrating an object according to an embodiment of the present invention.

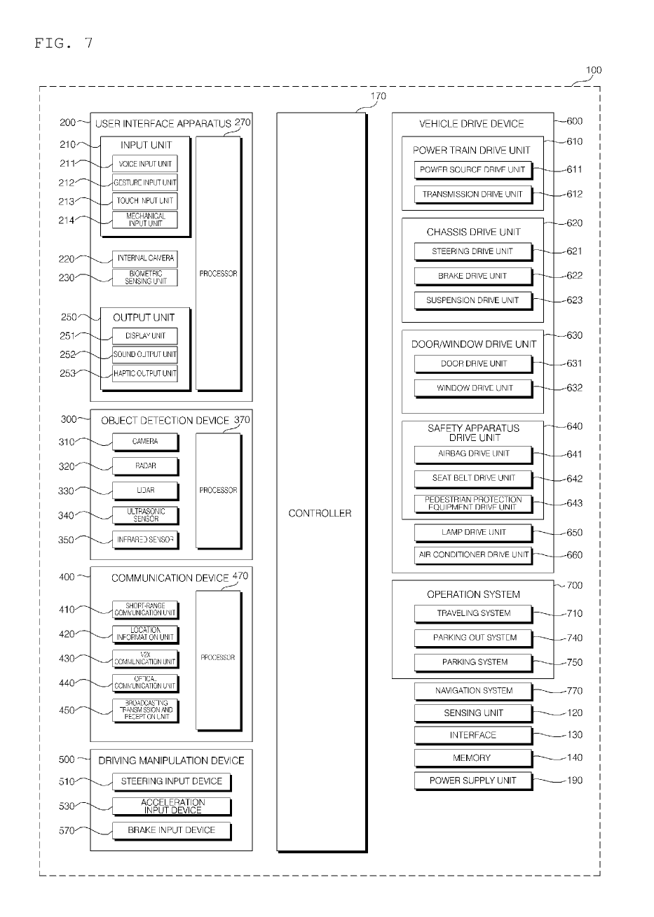

FIG. 7 is a block diagram illustrating a vehicle according to an embodiment of the present invention.

Referring to FIGS. 1 to 7, a vehicle 100 may include a wheel rotated by a power source, and a steering input device 510 for controlling a traveling direction of the vehicle 100.

The vehicle 100 may be an autonomous vehicle.

The vehicle 100 may be switched to an autonomous traveling mode or a manual mode, based on a user input.

For example, based on a user input received through a user interface apparatus 200, the vehicle 100 may be switched from a manual mode to an autonomous traveling mode, or vice versa.

The vehicle 100 may also be switched to an autonomous traveling mode or a manual mode based on traveling state information.

The traveling state information may be generated based on at least one of information on an object outside the vehicle 100, navigation information, and vehicle state information.

For example, the vehicle 100 may be switched from the manual mode to the autonomous traveling mode, or vice versa, based on traveling state information generated by the object detection device 300.

For example, the vehicle 100 may be switched from the manual mode to the autonomous traveling mode, or vice versa, based on traveling state information received through a communication device 400.

The vehicle 100 may be switched from the manual mode to the autonomous traveling mode, or vice versa, based on information, data, and a signal provided from an external device.

When the vehicle 100 operates in the autonomous traveling mode, the autonomous vehicle 100 may operate based on an operation system 700.

For example, the autonomous vehicle 100 may operate based on information, data, or signal generated by a traveling system 710, a parking out system 740, and a parking system 750.

While operating in the manual mode, the autonomous vehicle 100 may receive a user input for driving of the vehicle 100 through a driving manipulation device 500. Based on the user input received through the driving manipulation device 500, the vehicle 100 may operate.

The term “overall length” means the length from the front end to the rear end of the vehicle 100, the term “width” means the width of the vehicle 100, and the term “height” means the length from the bottom of the wheel to the roof. In the following description, the term “overall length direction L” may mean the reference direction for the measurement of the overall length of the vehicle 100, the term “width direction W” may mean the reference direction for the measurement of the width of the vehicle 100, and the term “height direction H” may mean the reference direction for the measurement of the height of the vehicle 100.

As illustrated in FIG. 7, the vehicle 100 may include the user interface apparatus 200, the object detection device 300, the communication device 400, the driving manipulation device 500, a vehicle drive device 600, the operation system 700, a navigation system 770, a sensing unit 120, an interface 130, a memory 140, a controller 170, and a power supply unit 190.

According to an embodiment, the vehicle 100 may further include other components in addition to the components mentioned in this specification, or may not include some of the mentioned components.

The user interface apparatus 200 is provided to support communication between the vehicle 100 and a user. The user interface apparatus 200 may receive a user input, and provide information generated in the vehicle 100 to the user. The vehicle 100 may implement User Interfaces (UI) or User Experience (UX) through the user interface apparatus 200.

The user interface apparatus 200 may include an input unit 210, an internal camera 220, a biometric sensing unit biometric sensing unit 230, an output unit 250, and a processor 270.

According to an embodiment, the user interface apparatus 200 may further include other components in addition to the mentioned components, or may not include some of the mentioned components.

The input unit 210 is configured to receive information from a user, and data collected in the input unit 210 may be analyzed by the processor 270 and then processed by a control command of the user.

The input unit 210 may be disposed inside the vehicle 100. For example, the input unit 210 may be disposed in an area of a steering wheel, an area of an instrument panel, an area of a seat, an area of each pillar, an area of a door, an area of a center console, an area of a head lining, an area of a sun visor, an area of a windshield, or an area of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170.

The voice input unit 211 may include one or more microphones.

The gesture input unit 212 may convert a gesture input of a user into an electrical signal. The converted electrical signal may be provided to the processor 270 or the controller 170.

The gesture input unit 212 may include at least one of an infrared sensor and an image sensor for sensing a gesture input of a user.

According to an embodiment, the gesture input unit 212 may sense a three-dimensional (3D) gesture input of a user. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal, and the converted electrical signal may be provided to the processor 270 or the controller 170.

The touch input unit 213 may include a touch sensor for sensing a touch input of a user.

According to an embodiment, the touch input unit 210 may be integrally formed with a display unit 251 to implement a touch screen. Such a touch screen may provide an input interface and an output interface between the vehicle 100 and the user.

The mechanical input unit 214 may include at least one of a button, a dome switch, a jog wheel, and a jog switch. An electrical signal generated by the mechanical input unit 214 may be provided to the processor 270 or the controller 170.

The mechanical input unit 214 may be disposed on a steering wheel, a center fascia, a center console, a cockpit module, a door, etc.

The internal camera 220 may acquire images of the inside of the vehicle 100. The processor 270 may sense a user's state based on the images of the inside of the vehicle. The processor 270 may acquire information on an eye gaze of the user from the images of the inside of the vehicle. The processor 270 may sense a gesture of the user from the images of the inside of the vehicle.

The biometric sensing unit biometric sensing unit 230 may acquire biometric information of the user. The biometric sensing unit biometric sensing unit 230 may include a sensor for acquiring biometric information of the user, and may utilize the sensor to acquire finger print information, iris-scan information, retina-scan information, hand geo-metry information, facial recognition information, voice recognition information, etc. of the user. The biometric information may be used for user authentication.

The output unit 250 is configured to generate an output related to visual, auditory, or tactile sense.

The output unit 250 may include at least one of a display unit 251, a sound output unit 252, and a haptic output unit 253.

The display unit 251 may display graphic objects corresponding to various types of information.

The display unit 251 may include at least one of a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form a mutual layer structure together with the touch input unit 213, or may be integrally formed with the touch input unit 213 to implement a touch screen.

The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window.

The transparent display may display a certain screen with a certain transparency. In order to achieve the transparency, the transparent display may include at least one of a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

Meanwhile, the user interface apparatus 200 may include a plurality of display units 251a to 251g.

The display unit 251 may be disposed in an area of a steering wheel, an area 251a, 251b, or 251e of an instrument panel, an area 251d of a seat, an area 251f of each pillar, an area 251g of a door, an area of a center console, an area of a head lining, an area of a sun visor, an area 251c of a windshield, or an area 251h of a window.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface apparatus 200.

According to an embodiment, the user interface apparatus 200 may include a plurality of processors 270 or may not include the processor 270.

When the user interface apparatus 200 does not include the processor 270, the user interface apparatus 200 may operate under the control of the controller 170 or a processor of other device inside the vehicle 100.

Meanwhile, the user interface apparatus 200 may be referred to as a display device for vehicle.

The user interface apparatus 200 may operate under the control of the controller 170.

The object detection device 300 is an apparatus for detecting an object disposed outside the vehicle 100. The object detection device 300 may generate object information based on sensing data.

The object information may include information related to existence of an object, location information of an object, information on a distance between the vehicle 10 and the object, and information on relative speed of the vehicle 100 and the object.

The object may be various objects related to travelling of the vehicle 100.

Referring to FIGS. 5 and 6, an object o may include a lane OB10, a nearby vehicle OB11, a pedestrian OB12, a two-wheeled vehicle OB13, a traffic signal OB14 and OB15, a light, a road, a structure, a bump, a geographical feature, an animal, etc.

The lane OB10 may be a traveling lane, a side lane of the traveling lane, or a lane on which the opposed vehicle travels. The lane OB10 may be left and right lines that define the lane.

The nearby vehicle OB11 may be a vehicle that is travelling in the vicinity of the vehicle 100. The nearby vehicle OB11 may be a vehicle within a certain distance from the vehicle 100. For example, the nearby vehicle OB11 may be a vehicle that is preceding or following the vehicle 100.

The pedestrian OB12 may be a person in the vicinity of the vehicle 100. The pedestrian OB12 may be a person within a certain distance from the vehicle 100. For example, the pedestrian OB12 may be a person on a sidewalk or on the roadway.

The two-wheeled vehicle OB13 may be a vehicle that is disposed in the vicinity of the vehicle 100 and moves by using two wheels. The two-wheeled vehicle OB13 may be a vehicle that has two wheels positioned within a certain distance from the vehicle 100. For example, the two-wheeled vehicle OB13 may be a motorcycle or a bike on a sidewalk or the roadway.

The traffic signal may include a traffic light OB15, a traffic sign plate OB14, and a pattern or text painted on a road surface.

The light may be light generated by a lamp provided in the nearby vehicle. The light may be light generated by a street lamp. The light may be solar light.

The road may include a road surface, a curve, and slopes, such as an upward slope and a downward slope.

The structure may be a body that is disposed around the road and is fixed onto the ground. For example, the structure may include a street lamp, a roadside tree, a building, a telephone pole, a traffic light, and a bridge.

The geographical feature may include a mountain and a hill.

Meanwhile, the object may be classified into a movable object and a stationary object. For example, the movable object may include a nearby vehicle and a pedestrian. For example, the stationary object may include a traffic signal, a road, and a structure.

The object detection device 300 may include a camera 310, a radar 320, a lidar 330, an ultrasonic sensor 340, an infrared sensor 350, and a processor 370.

According to an embodiment, the object detection device 300 may further include other components in addition to the mentioned components, or may not include some of the mentioned components.

The camera 310 may be disposed at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

Further, the camera 310 may acquire location information of an object, information on a distance to the object, or information on a relative speed to the object, by using various image processing algorithms.

For example, the camera 310 may acquire the information on the distance to the object and information on the relative speed to the object, based on change over time in size of the object, from the acquired image.

For example, the camera 310 may acquire the information on the distance to the object and information on the relative speed to the object, by using a pin hole model or profiling a road surface.

For example, the camera 310 may acquire the information on the distance to the object and the information on the relative speed to the object, based on information on disparity, from stereo image acquired by a stereo camera 310a.

For example, the camera 310 may be disposed near a front windshield in the vehicle 100 in order to acquire images of the front of the vehicle 100. Alternatively, the camera 310 may be disposed around a front bumper or a radiator grill.

For example, the camera 310 may be disposed near a rear glass in the vehicle 100 in order to acquire images of the rear of the vehicle 100. Alternatively, the camera 310 may be disposed around a rear bumper, a trunk, or a tailgate.

For example, the camera 310 may be disposed near at least one of the side windows in the vehicle 100 in order to acquire images of the lateral side of the vehicle 100. Alternatively, the camera 310 may be disposed around a side mirror, a fender, or a door.

The camera 310 may provide an acquired image to the processor 370.

The radar 320 may include an electromagnetic wave transmission unit and an electromagnetic wave reception unit. The radar 320 may be implemented by a pulse radar scheme or a continuous wave radar scheme depending on the principle of emission of an electronic wave. The radar 320 may be implemented by a Frequency Modulated Continuous Wave (FMCW) scheme or a Frequency Shift Keying (FSK) scheme depending on the waveform of a signal.

The radar 320 may detect an object by using an electromagnetic wave as medium based on a time of flight (TOF) scheme or a phase-shift scheme, and may detect a position of the detected object, the distance to the detected object, and the relative speed to the detected object.

The radar 320 may be disposed at an appropriate position outside the vehicle 100 in order to detect an object disposed in front of the vehicle 100, in the rear side of the vehicle 100, or in the lateral side of the vehicle 100.

The lidar 330 may include a laser transmission unit and a laser reception unit. The lidar 330 may be implemented by the Time of Flight (TOF) scheme or the phase-shift scheme.

The lidar 330 may be implemented as a drive type lidar or a non-drive type lidar. When implemented as the drive type lidar, the lidar 300 may rotate by a motor and detect an object in the vicinity of the vehicle 100.

When implemented as the non-drive type lidar, the lidar 300 may detect an object disposed within a certain range based on the vehicle 100, due to a light steering. The vehicle 100 may include a plurality of non-drive type lidars 330.

The lidar 330 may detect an object through the medium of laser light by employing the TOF scheme or the phase-shift scheme, and may detect a position of the detected object, the distance to the detected object, and the relative speed to the detected object.

The lidar 330 may be disposed at an appropriate position outside the vehicle 100 in order to detect an object disposed in front of the vehicle 100, disposed in the rear side of the vehicle 100, or in the lateral side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a position of the detected object, the distance to the detected object, and the relative speed to the detected object.

The ultrasonic sensor 340 may be disposed at an appropriate position outside the vehicle 100 in order to detect an object disposed in front of the vehicle 100, disposed in the rear side of the vehicle 100, or in the lateral side of the vehicle 100.

The infrared sensor 350 may include an infrared light transmission unit and an infrared light reception unit. The infrared sensor 350 may detect an object based on infrared light, and may detect a position of the detected object, the distance to the detected object, and the relative speed to the detected object.

The infrared sensor 350 may be disposed at an appropriate position outside the vehicle 100 in order to detect an object disposed in front of the vehicle 100, disposed in the rear side of the vehicle 100, or in the lateral side of the vehicle 100.

The processor 370 may control the overall operation of each unit of the object detection device 300.

The processor 370 may detect and classify an object by comparing data sensed by the camera 310, the radar 320, the lidar 330, the ultrasonic sensor 340, and the infrared sensor 350 with pre-stored data.

The processor 370 may detect and track an object based on acquired images. The processor 370 may calculate the distance to the object, the relative speed to the object, and the like by using image processing algorithms.

For example, the processor 370 may acquire information on the distance to the object and information on the relative speed to the object, based on change over time in size of the object, from the acquired image.

For example, the processor 370 may acquire information on the distance to the object or information on the relative speed to the object by employing a pin hole model or by profiling a road surface.

For example, the processor 370 may acquire information on the distance to the object and information on the relative speed to the object based on information on disparity from the stereo image acquired by the stereo camera 310a.

The processor 370 may detect and track an object, based on a reflection electromagnetic wave which is formed as a transmitted electromagnetic wave is reflected by the object and returned. Based on the electromagnetic wave, the processor 370 may calculate the distance to the object, the relative speed to the object, and the like.

The processor 370 may detect and track an object based on a reflection laser light which is formed as a transmitted laser light is reflected by the object and returned. Based on the laser light, the processor 370 may calculate the distance to the object, the relative speed to the object, and the like.

The processor 370 may detect and track an object based on a reflection ultrasonic wave which is formed as a transmitted ultrasonic wave is reflected by the object and returned. Based on the ultrasonic wave, the processor 370 may calculate the distance to the object, the relative speed to the object, and the like.

The processor 370 may detect and track an object based on reflection infrared light which is formed as a transmitted infrared light is reflected by the object and returned. Based on the infrared light, the processor 370 may calculate the distance to the object, the relative speed to the object, and the like.

According to an embodiment, the object detection device 300 may include a plurality of processors 370 or may not include the processor 370. For example, each of the camera 310, the radar 320, the lidar 330, the ultrasonic sensor 340, and the infrared sensor 350 may include its own processor individually.

When the object detection device 300 does not include the processor 370, the object detection device 300 may operate under the control of the controller 170 or a processor inside the vehicle 100.

The object detection device 300 may operate under the control of the controller 170.

The communication device 400 is an apparatus for performing communication with an external device. Here, the external device may be a nearby vehicle, a mobile terminal, or a server.

In order to perform communication, the communication device 400 may include at least one of a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcasting transmission and reception unit 450, an Intelligent Transport Systems (ITS) communication unit 460, and a processor 470.

According to an embodiment, the communication device 400 may further include other components in addition to the mentioned components, or may not include some of the mentioned components.

The short-range communication unit 410 is configured to perform short-range communication. The short-range communication unit 410 may support short-range communication by using at least one of Bluetoothm, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless Universal Serial Bus (Wireless USB).

The short-range communication unit 410 may form wireless area networks to perform short-range communication between the vehicle 100 and at least one external device.

The location information unit 420 is a unit for acquiring location information of the vehicle 100. For example, the location information unit 420 may include a Global Positioning System (GPS) module or a Differential Global Positioning System (DGPS) module.

The V2X communication unit 430 is a unit for performing wireless communication with a server (vehicle to infra (V2I) communication), a nearby vehicle (vehicle to vehicle (V2V) communication), or a pedestrian (vehicle to pedestrian (V2P) communication). The V2X communication unit 430 may include an RF circuit capable of implementing protocols for a communication with the infra (V2I), an inter-vehicle communication (V2V), and a communication with the pedestrian (V2P).

The optical communication unit 440 is a unit for performing communication with an external device by using light as medium. The optical communication unit 440 may include a light emitting unit, which converts an electrical signal into an optical signal and transmits the optical signal to the outside, and a light receiving unit which converts a received optical signal into an electrical signal.

According to an embodiment, the light emitting unit may be integrally formed with a lamp included in the vehicle 100.

The broadcasting transmission and reception unit 450 is a unit for receiving a broadcast signal from an external broadcasting management server or transmitting a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information or data to the traffic system. The ITS communication unit 460 may receive information, data, or signals from the traffic system. For example, the ITS communication unit 460 may receive traffic information from the traffic system and provide the traffic information to the controller 170. For example, the ITS communication unit 460 may receive a control signal from the traffic system, and provide the control signal to the controller 170 or a processor provided in the vehicle 100.

The processor 470 may control the overall operation of each unit of the communication device 400.

According to an embodiment, the communication device 400 may include a plurality of processors 470, or may not include the processor 470.

When the communication device 400 does not include the processor 470, the communication device 400 may operate under the control of the controller 170 or a processor of other device inside of the vehicle 100.

In addition, the communication device 400 may implement a vehicle display device, together with the user interface apparatus 200. In this case, the vehicle display device may be referred to as a telematics device or an Audio Video Navigation (AVN) device.

The communication device 400 may operate under the control of the controller 170.

The driving manipulation device 500 is configured to receive a user input for driving.

In the case of manual mode, the vehicle 100 may operate based on a signal provided by the driving manipulation device 500.

The driving manipulation device 500 may include a steering input device 510, an acceleration input device 530, and a brake input device 570.

The steering input device 510 may receive an input of travel direction of the vehicle 100 from a user. It is preferable that the steering input device 510 is implemented in a form of a wheel to achieve a steering input through a rotation. According to an embodiment, the steering input device may be implemented in a form of a touch screen, a touch pad, or a button.

The acceleration input device 530 may receive an input for acceleration of the vehicle 100 from a user. The brake input device 570 may receive an input for deceleration of the vehicle 100 from a user. It is preferable that the acceleration input device 530 and the brake input device 570 are implemented in the form of a pedal. According to an embodiment, the acceleration input device or the brake input device may be implemented in the form of a touch screen, a touch pad, or a button.

The driving manipulation device 500 may operate under the control of the controller 170.

The vehicle drive device 600 is configured to electrically control the operation of various devices of the vehicle 100.

The vehicle drive device 600 may include a power train drive unit 610, a chassis drive unit 620, a door/window drive unit 630, a safety apparatus drive unit 640, a lamp drive unit 650, and an air conditioner drive unit 660.

According to an embodiment, the vehicle drive device 600 may further include other components in addition to the mentioned components, or may not include some of the mentioned components.

In addition, the vehicle drive device 600 may include a processor. Each unit of the vehicle drive device 600 may include its own processor individually.

The power train drive unit 610 may control the operation of a power train apparatus.

The power train drive unit 610 may include a power source drive unit 611 and a transmission drive unit 612.

The power source drive unit 611 may control a power source of the vehicle 100.

For example, when a fossil fuel-based engine is the power source, the power source drive unit 611 may perform electronic control of the engine. Thus, the output torque of the engine can be controlled. The power source drive unit 611 may adjust the output toque of the engine under the control of the controller 170.

For example, when an electric motor is the power source, the power source drive unit 611 may control the motor. The power source drive unit 610 may adjust the RPM, toque, and the like of the motor under the control of the controller 170. The transmission drive unit 612 may control a transmission. The transmission drive unit 612 may adjust the state of the transmission.

The transmission drive unit 612 may adjust a state of the transmission. The transmission drive unit 612 may adjust a state of the transmission to a drive (D), reverse (R), neutral (N), or park (P) state.

Meanwhile, when an engine is the power source, the transmission drive unit 612 may adjust a gear-engaged state, in the drive D state.

The chassis drive unit 620 may control the operation of a chassis

The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the travel direction of the vehicle 100.

The brake drive unit 622 may perform electronic control of a brake apparatus provided inside the vehicle 100. For example, the brake drive unit 622 may reduce the speed of the vehicle 100 by controlling the operation of a brake disposed in a wheel.

Meanwhile, the brake drive unit 622 may control a plurality of brakes individually. The brake drive unit 622 may control the braking forces applied to the plurality of wheels to be different from each other.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100.

Meanwhile, the suspension drive unit 623 may control a plurality of suspensions individually.

The door/window drive unit 630 may perform electronic control of a door apparatus or a window apparatus inside the vehicle 100.

The door/window drive unit 630 may include a door drive unit 631 and a window drive unit 632.

The door drive unit 631 may control the door apparatus, and control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window apparatus and control opening or closing of a plurality of windows included in the vehicle 100.

The safety apparatus drive unit 640 may perform electronic control of various safety apparatuses provided inside the vehicle 100

The safety apparatus drive unit 640 may include an airbag drive unit 641, a seat belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The seat belt drive unit 642 may perform electronic control of a seatbelt apparatus inside the vehicle 100. For example, upon detection of a dangerous situation, the seat belt drive unit 642 may control passengers to be fixed onto seats 110FL, 110FR, 110RL, and 110RR by using a safety belt.

The pedestrian protection equipment drive unit 643 may perform electronic control of a hood lift and a pedestrian airbag. For example, upon detection of a collision with a pedestrian, the pedestrian protection equipment drive unit 643 may control the hood lift to be lifted up and the pedestrian airbag to be deployed.

The lamp drive unit 650 may perform electronic control of various lamp apparatuses provided inside the vehicle 100.

The air conditioner drive unit 660 can perform electronic control of an air conditioner inside the vehicle 100. For example, when the inner temperature of the vehicle 100 is high, the air conditioner drive unit 660 may operate the air conditioner to supply cool air to the inside of the vehicle.

In addition, the vehicle drive device 600 may include a processor. Each unit of the vehicle dive device 600 may include its own processor individually. The vehicle drive device 600 may operate under the control of the controller 170.

The operation system 700 is a system for controlling various operations of the vehicle 100. The operation system 700 may operate in the autonomous traveling mode.

The operation system 700 may include the traveling system 710, the parking out system 740, and the parking system 750.

According to an embodiment, the operation system 700 may further include other components in addition to the mentioned components, or may not include some of the mentioned component.

Meanwhile, the operation system 700 may include a processor. Each unit of the operation system 700 may include its own processor.

Meanwhile, according to an embodiment, when the operation system 700 is implemented in software, it may be a subordinate concept of the controller 170.

According to an embodiment, the operation system 700 may be a concept including at least one of the user interface apparatus 200, the object detection device 300, the communication device 400, the driving manipulation device 500, the vehicle drive device 600, the navigation system 770, and the sensing unit 120, and the controller 170.

The traveling system 710 may perform traveling of the vehicle 100. The traveling system 710 may perform traveling of the vehicle 100, by receiving navigation information from the navigation system 770 and providing a control signal to the vehicle drive device 600.

The traveling system 710 may perform traveling of the vehicle 100, by receiving object information from the object detection device 300, and providing a control signal to the vehicle drive device 600.

The traveling system 710 may perform traveling of the vehicle 100, by receiving a signal from an external device through the communication device 400 and providing a control signal to the vehicle drive device 600.

The traveling system 710 may include at least one of the user interface apparatus 270, the object detection device 300, the communication device 400, the driving manipulation device 500, the vehicle drive device 600, the navigation system 770, the sensing unit 120, and the controller to perform traveling of the vehicle 100.

Such a traveling system 710 may be referred to as a vehicle traveling control apparatus.

The parking-out system 740 may perform the parking-out of the vehicle 100.

The parking-out system 740 may move the vehicle 100 out of a parking space, by receiving navigation information from the navigation system 770 and providing a control signal to the vehicle drive device 600.

The parking-out system 740 may move the vehicle 100 out of a parking space, by receiving object information from the object detection device 300 and providing a control signal to the vehicle drive device 600.

The parking-out system 740 may move the vehicle 100 out of a parking space, by receiving a signal from an external device and providing a control signal to the vehicle drive device 600.

The parking-out system 740 may include at least one of the user interface apparatus 270, the object detection device 300, the communication device 400, the driving manipulation device 500, the vehicle drive device 600, the navigation system 770, the sensing unit 120, and the controller 170 to move the vehicle 100 out of a parking space. Such a parking-out system 740 may be referred to as a vehicle parking-out control apparatus.

The parking system 750 may park the vehicle 100.

The parking system 750 may park the vehicle 100, by receiving navigation information from the navigation system 770 and providing a control signal to the vehicle drive device 600.

The parking system 750 may park the vehicle 100, by receiving object information from the object detection device 300 and providing a control signal to the vehicle drive device 600.

The parking system 750 may park the vehicle 100, by receiving a signal from an external device through the communication device 400, and providing a control signal to the vehicle drive device 600.

The parking system 750 may include at least one of the user interface apparatus 270, the object detection device 300, the communication device 400, the driving manipulation device 500, the vehicle drive device 600, the navigation system 770, the sensing unit 120, and the controller 170 to park the vehicle 100 in a parking space.

Such a parking system 750 may be referred to as a vehicle parking control apparatus.

The navigation system 770 may provide navigation information.

The navigation system 770 may include at least one of map information, information on set destination, path information due to the set destination, information on various objects on the path, lane information, and information on the current position of vehicle.

The navigation system 770 may include a memory and a processor. The memory may store navigation information. The processor may control the operation of the navigation system 770.

According to an embodiment, the navigation system 770 may also update pre-stored information by receiving information from an external device through the communication device 400.

According to an embodiment, the navigation system 770 may be classified as an element of the user interface apparatus 200.

The sensing unit 120 may sense the state of the vehicle. The sensing unit 120 may include a posture sensor (e.g., a yaw sensor, a roll sensor, or a pitch sensor), a collision sensor, a wheel sensor, a speed sensor, a tilt sensor, a weight sensor, a heading sensor, a yaw sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, a brake pedal position sensor, and the like.

The sensing unit 120 may also acquire sensing signals related to vehicle posture information, vehicle collision information, vehicle direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, vehicle external illumination information, information on the pressure applied to accelerator pedal, information on the pressure applied to brake pedal, and the like.

The sensing unit 120 may further include an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, a Crank Angle Sensor (CAS), and the like.

The sensing unit 120 may generate vehicle state information based on sensing data. The vehicle state information may be information that is generated based on data sensed by a variety of sensors provided inside a vehicle.

For example, the vehicle state information may include vehicle posture information, vehicle speed information, vehicle tilt information, vehicle weight information, vehicle direction information, vehicle battery information, vehicle fuel information, vehicle tire pressure information, vehicle steering information, in-vehicle temperature information, in-vehicle humidity information, pedal position information, vehicle engine temperature information, etc.

The interface 130 may serve as a passage for various types of external devices that are connected to the vehicle 100. For example, the interface 130 may have a port that is connectable to a mobile terminal and may be connected to the mobile terminal via the port. In this case, the interface 130 may exchange data with the mobile terminal.

Meanwhile, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under the control of the controller 170.

The memory 140 is electrically connected to the controller 170. The memory 140 may store basic data for each unit, control data for the operation control of each unit, and input/output data. The memory 140 may be various storage devices, in hardware, such as a ROM, a RAM, an EPROM, a flash drive, a hard drive, and the like. The memory 140 may store various data for the overall operation of the vehicle 100, such as programs for the processing or control of the controller 170.

According to an embodiment, the memory 140 may be integrally formed with the controller 170, or may be provided as an element of the controller 170.

The controller 170 may control the overall operation of each unit inside the vehicle 100. The controller 170 may be referred to as an Electronic Control Unit (ECU).

The power supply unit 190 may supply power required to operate each component under the control of the controller 170. In particular, the power supply unit 190 may receive power from a battery or the like inside the vehicle 100.

At least one processor and the controller 170 included in the vehicle 100 may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

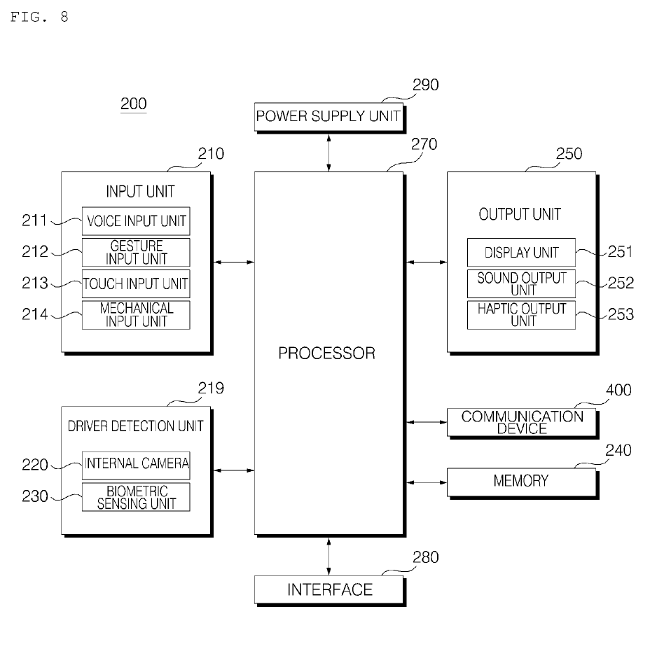

FIG. 8 is a block diagram illustrating a user interface apparatus for a vehicle according to an embodiment of the present invention.

Referring to FIG. 8, the user interface apparatus 200 for a vehicle may include an input unit 210, a driver detection unit 219, a memory 240, an output unit 250, a processor 270, an interface 280, and a power supply unit 290.

According to an embodiment, the user interface apparatus 200 may further include the communication device 400.

The explanation described with reference to FIG. 7 may be applied to the input unit 210 and the output unit 250.

The driver detection unit 219 may detect an occupant. Here, the occupant may include the driver of the vehicle 100. The occupant may be referred to as a user of vehicle.

The driver detection unit 219 may include an internal camera 220 and a biometric sensing unit 230.

The explanation described with reference to FIG. 7 may be applied to the internal camera 220.

The explanation described with reference to FIG. 7 may be applied to the biometric sensing unit 230.

The memory 240 is electrically connected to the processor 270. The memory 240 may store basic data for each unit, control data for the operation control of each unit, and input/output data. The memory 240 may be various hardware storage devices in hard ware, such as a ROM, a RAM, an EPROM, a flash drive, a hard drive, and the like. The memory 240 may store various data for the overall operation of the user interface apparatus 200, such as programs for the processing or control of the processor 270.

According to an embodiment, the memory 240 may be integrally formed with the processor 270, or may be an element of the processor 270.

The memory 240 may store traveling history information of the driver.

When the vehicle 100 is used by a plurality of drivers, the memory 240 may classify each of the plurality of drivers and store the traveling history information.

The memory 240 may store movement pattern information corresponding to the past movement route of the driver.

Here, the movement pattern information may include traveling function information utilized during traveling of the movement route.

For example, the memory 250 may store information of a first traveling function and information of a second traveling function utilized during traveling of a first path.

The memory 240 may store a traveling image.

Here, the traveling image may be an image acquired through the camera 310 when the vehicle 100 travels. Alternatively, the traveling image may be an image received from an external device of vehicle through the communication device 400.

The traveling image may include traveling function information utilized when the vehicle 100 travels.

For example, a first traveling image stored in the memory 250 may include the information of the first traveling function and the information of the second traveling function utilized at the time when the first traveling image is photographed.

The memory 240 may store driver information.

The driver information may include reference information for driver authentication.

For example, the memory 240 may store driver authentication information based on a face image of the driver.

When the driver first gets in the vehicle 100, the internal camera 220 may photograph the face of the driver.

At this time, the photographed image of the driver's face is stored in the memory 240 and used as reference image information for driver authentication.

For example, the memory 240 may store driver authentication information based on biometric information of the driver.

When the driver first gets in the vehicle 100, the biometric sensing unit 230 may acquire the biometric information of the driver.

At this time, the acquired biometric information of the driver is stored in the memory 240 and may be used as reference biometric information for driver authentication.

The processor 270 may control the overall operation of each unit of the user interface apparatus 200.

The processor 270 may store the driver's traveling history information in the memory 240. The processor 270 may accumulate and store the traveling history information at the time of traveling by the driver, after performing the driver authentication through the driver detection unit 219.

If the vehicle 100 is used by a plurality of drivers, the processor 270 may classify each of the plurality of drivers and store the traveling history information in the memory 240.

The traveling history information may include movement pattern information, traveling image information, driving career information, accumulated traveling distance information, accident information, traffic regulation violation information, traveling route information, traveling function use information, and the like.

The processor 270 may store the driver's movement pattern information in the memory 240.

Here, the movement pattern information may include traveling function information utilized when the vehicle 100 travels.

For example, the processor 270 may store the movement pattern information in the memory 240 when a specific driver is traveling along a certain movement route.

The processor 270 may store the traveling image in the memory 240.

Here, the traveling image may be an image acquired through the camera 310 when the vehicle 100 travels while the driver is boarding.

The processor 270 may acquire the driver information through the driver detection unit 219.

When the driver gets in the vehicle 100, the internal camera 220 may photograph the driver.

The processor 270 may compare the driver image photographed by the internal camera 220 with the reference image stored in the memory 240 to perform driver authentication.

When the driver gets in the vehicle 100, the biometric sensing unit 230 may detect biometric information of the driver.

The processor 270 may compare the biometric information of the driver detected by the biometric sensing unit 230 with the reference biometric information stored in the memory 240 to perform the driver authentication.

After performing the authentication, the processor 270 may receive information of the authenticated driver from the memory 240. Here, the driver information may include the traveling history information.

The processor 270 may determine the driver level of the driver based on the driver information.

The processor 270 may determine the driver level of the driver based on the driver's traveling history information.

The processor 270 may determine the driver level of the driver by dividing the driver level into a plurality of levels.

For example, the processor 270 may determine the driver level of the driver as a beginner, an intermediate, and an expert.

For example, the processor 270 may determine the driver level of the driver by classifying the driver level into a vehicle function beginner and a vehicle function expert. The processor 270 may classify the vehicle function beginner and the vehicle function expert based on the number of times of using the traveling function. For example, when the traveling function is used a reference number of times or less, the processor 270 may classify the driver as a vehicle function beginner. For example, when the traveling function is used more than the reference number of times, the processor 270 may classify the driver as a vehicle function expert.

For example, the processor 270 may determine the driver level of the driver, based on accumulated travel distance information of the driver.

For example, the processor 270 may determine the driver level of the driver, based on information of the number of times of accidents of the driver.

For example, the processor 270 may determine the driver level of the driver, based on information of the number of times of traffic violation of the driver.

The processor 270 may select the traveling function, based on the driving level of the driver among a plurality of traveling functions that can be implemented in the vehicle 100.

The traveling function may be any one of the functions of the Advanced Driver Assistance System (ADAS).

For example, the functions of the Advanced Driver Assistance System may include Autonomous Emergency Braking (AEB), Forward Collision Warning (FCW), Lane Departure Warning (LDW), Lane Keeping Assist (LKA), Lane Change Alert (LCA), Speed Assist System (SAS), Traffic Sign Recognition (TSR), High Beam Assist (HBA), Low Beam Assist (LBA), Blind Spot Detection (BSD), Autonomous Emergency Steering (AES), Curve Speed Warning System (CSWS), Adaptive Cruise Control (ACC), Target Following Assist (TFA), Smart Parking Assist System (SPAS), Traffic Jam Assist (TJA), Around View Monitor (AVM), and an automatic parking.

The traveling function may be any one of the functions of the autonomous vehicle.

For example, the function of the autonomous vehicle may include an autonomous traveling function, a partial autonomous traveling function, a cooperative traveling function, and a manual traveling function.

Here, the partial autonomous traveling function may mean a function of performing autonomous traveling inly in a certain traveling state or a certain traveling section.

Here, the cooperative traveling function may mean a function performed in a state where the function of the above-described advanced driver assistance system is provided.

The processor 270 may control the output unit 250 to output information on the selected traveling function.

The processor 270 may visually output information on the traveling function through the display unit 251.

The processor 270 may output the information on the traveling function in an audible manner through the sound output unit 252.

The processor 270 may tactually output information on the traveling function through the haptic output unit 253.

The processor 270 may provide a control signal to the vehicle drive device 600 so that the vehicle 100 can travel based on the selected traveling function. For example, the processor 270 may provide a control signal to at least one of a power source drive unit 611, a steering drive unit 621, and a brake drive unit 622.

The processor 270 may provide a control signal to the vehicle drive device 600 so that the vehicle 100 can travel based on the selected traveling function, when a user input is received through the input unit 210 in a state in which information on the selected traveling function is outputted.

Here, the traveling function that is selected and outputted may be referred to as a recommended traveling function based on the driver level.

The processor 270 may provide a control signal to vehicle drive device 600, when a user input requesting execution of the recommended traveling function is performed by user input in the state where the recommended traveling function is outputted.

The processor 270 may determine the driver type of the driver based on the driver information.

The processor 270 may acquire the physical feature information of the driver, based on the internal camera 220.

For example, the processor 270 may determine the driver type of the driver as any one of an old man, a disabled, a pregnant woman, and a normal person based on the physical characteristics of the driver.

The processor 270 may determine the driver type of the driver, based on the traveling history information of driver.

The processor 270 may determine the driver type, based on the user input received through the input unit 210.

The processor 270 may select the traveling function, based on the driver type.

For example, the processor 270 may select the traveling function by a combination of the driver type and the driver level.

The processor 270 may determine the traveling state of the vehicle 100, and select the traveling function based on information on the traveling state.

For example, the processor 270 may select the traveling function by a combination of the information on the traveling state and the driving level of the driver.

Here, the information on the traveling state may be generated based on at least one of object information outside the vehicle, navigation information, and vehicle state information.

For example, the processor 270 may determine that the vehicle is traveling in the city, based on at least one of traveling road information, road surrounding structure information, traveling speed information, and location information, and may select the traveling function, based on city traveling condition information and the driving level of driver.

For example, the processor 270 may determine that the vehicle is traveling in a curve road, based on at least one of the traveling road information, the steering sensing information, and the location information, and may select the traveling function, based on the curve road traveling state and the driving level of driver.

For example, the processor 270 may determine that the vehicle is parking, based on at least one of traveling road information, nearby vehicle information, traffic sign information, traveling speed information, and location information, and may select the traveling function, based on parking situation information and the driving level of driver.

For example, the processor 270 may determine that the vehicle is traveling in a highway, based on at least one of traveling road information, traffic sign information, traveling speed information, and location information, and may select the traveling function, based on highway traveling state information and the driving level of driver.

For example, the processor 270 may determine that the vehicle is in the long-distance traveling state, based on at least one of the destination information, route information, and the location information, and may select the traveling function, based on long-distance traveling state information and the driving level of driver.

The processor 270 may control the output unit 250 to output a tutorial image corresponding to the traveling state information.

For example, the processor 270 may control to display the tutorial image through the HUD.

The tutorial image may include an operation demonstration image of the vehicle 100 by the selected traveling function.

For example, when the AEB is selected, the processor 270 may output an image representing the braking operation of the vehicle 100 by the AEB through the output unit 250.

For example, when LKA is selected, the processor 270 may output an image representing the traveling lane holding operation of the vehicle 100 by the LKA through the output unit 250.

For example, when the HBA is selected, the processor 270 may output an image representing the high beam control operation of the vehicle 100 by the HBA through the output unit 250.

For example, when ACC is selected, the processor 270 may output an image representing the preceding vehicle following operation of the vehicle 100 by the ACC through the output unit 250.

The processor 270 may control to output the operation information of the vehicle when performed according to vehicle manipulation guide information and guide information through the tutorial image.

The processor 270 may output the vehicle manipulation guide information in a case where the vehicle manipulation of the driver is required, when the tutorial image is being outputted.

The processor 270 may control to output information of the vehicle 100 that is operated when it is operated according to the vehicle manipulation guide information.

Meanwhile, the tutorial image may include a vehicle traveling simulation image.

The processor 270 may control to output guide information of the driving manipulation device 500 corresponding to the vehicle traveling simulation image through the output unit 250.

In this case, the processor 270 may control the graphic objects in the simulation image to move in response to a signal received from the driving manipulation device 500.

At this time, in response to the signal received from the driving manipulation device 500, the vehicle drive device 600 may not be driven.

Through such control, the driver may previously test the traveling function of the vehicle 100. Accordingly, the driver may understand the traveling function of the vehicle 100 according to the driver level, and utilize the traveling function at an appropriate time.

The processor 270 may select the traveling function, based on the movement pattern information previously stored in the memory 240, when traveling in a certain movement route.

Here, the movement route may be a past movement route pre-stored in the memory 240.

The processor 270 may store the movement pattern information of the movement route in the memory 240 when traveling in the movement route. Here, the movement pattern information may include traveling function information utilized at the time of traveling in the movement route.

The processor 270 may select the traveling function information utilized at the time of traveling in the past movement route stored in the memory 240, when the vehicle 100 travels again in the past traveled movement route.

The processor 270 may select any one of the traveling functions set in a plurality of steps, based on the driver level.

The processor 270 may control the output unit 250 to output information on functions provided in a plurality of steps.

Each of the traveling functions may be set in a plurality of steps.

For example, the AEB may be divided into three steps.

For example, when the AEB is selected in a first step, the processor 270 may provide a control signal to stop the vehicle 100 at a distance of 3 m from the front object. In this case, the processor 270 may output information on the first step AEB through the output unit 250.

For example, when the AEB is selected in a second step, the processor 270 may provide a control signal to stop the vehicle 100 at a distance of 2 m from the front object. In this case, the processor 270 may output information on the second step AEB through the output unit 250.

For example, when the AEB is selected in a third step, the processor 270 may provide a control signal to stop the vehicle 100 at a distance of 1 m from the front object. In this case, the processor 270 may output information on the third step AEB through the output unit 250.

The processor 270 may control to output the Ing image stored in the memory 240 through the output unit 250.

In a state in which the traveling image is outputted through the output unit 250, the processor 270 may receive a user input for any of a plurality of traveling functions outputted through the traveling image.

In this case, the processor 270 may control the output unit 250 to output information on the traveling function corresponding to the user input.

Here, the traveling image may be an image acquired through the camera 310 when the vehicle 100 travels. The traveling image may include traveling function information utilized when the vehicle 100 travels.

When outputting the traveling image, the processor 270 may output, together with the traveling image, the traveling function information utilized at the time when the traveling image is photographed.

The processor 270 may receive a user input for any one of a plurality of utilized traveling function information, while the traveling image is being outputted. The processor 270 may output information on the traveling function corresponding to the user input through the output unit 250. The processor 270 may provide a control signal to the vehicle drive device 600 so that the vehicle 100 travels based on the traveling function corresponding to the user input.

After turning on the vehicle, before the vehicle travels, the processor 270 may control to output information on a plurality of traveling functions through the output unit 250.

Such control may help the driver to select a traveling function suitable for him or her.

The processor 270 may set a mission of passing through a waypoint, based on the route information. The processor 270 may control to output the information on the mission through the output unit 250.

For example, the processor 270 may set a mission of passing through a waypoint by designating a restaurant close to a set route, a tourist spot, a famous resting place, or a drive course as a waypoint. When the mission is set, the processor 270 may output information on the mission.

The processor 270 may determine whether the mission is achieved, based on whether the vehicle 100 passes through a waypoint set as a mission. If the mission is achieved, the processor 270 may provide mission achievement information to the external device of vehicle through the communication device 400.

Here, the external device of vehicle may include a server (e.g., an SNS server), a mobile terminal, a personal PC, and other vehicle.

The processor 270 may receive compensation information corresponding to the mission achievement information from the external device of vehicle. The processor 270 may control to output the information on the compensation through the output unit 250.

Here, the compensation information may include information on mitigation of penalty points due to violation of traffic regulations, penalty discount, free fuel ticket, free car wash ticket, and the like.

The processor 270 may receive ranking information and trial membership information from the external device of vehicle and output it.

Here, the ranking information may be rank information of the driver, among a plurality of mission participants, according to the accumulated achievement of mission.

Here, the trial membership information may be experiential information of a manufacturer's test event provided as a reward for achieving the mission.

The interface 280 may exchange information, signals, or data with other devices included in the vehicle 100. The interface 280 may receive information, signals or data from other devices included in the vehicle 100. The interface 280 may transmit the received information, signals, or data to the processor 270. The interface 280 may transmit information, signals or data generated or processed by the processor 270 to other devices included in the vehicle 100.

The interface 280 may receive the object information from the object detection device 300.

The interface 280 may receive the navigation information from the navigation system 770.

For example, the interface 280 may receive route information from the navigation system 770.

The interface 280 may receive the vehicle state information from the sensing unit 120.

The information, signals or data received by the interface 280 may be provided to the processor 270.

The interface 280 may exchange signals with the driving manipulation device 500.

For example, the interface 280 may receive a signal generated by user's manipulation from the driving manipulation device 500.

The power supply unit 290 may supply power necessary for operation of each component under the control of the processor 270. Particularly, the power supply unit 290 may receive power from a battery or the like inside the vehicle.

The communication device 400 may exchange data with the external device of the vehicle 100.

The explanation described with reference to FIG. 7 may be applied to the communication device 400.

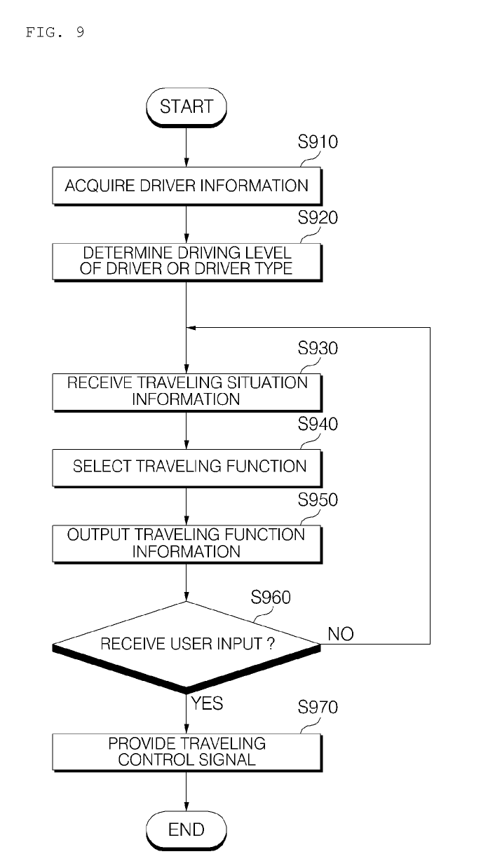

FIG. 9 is a flowchart illustrating an operation of a user interface apparatus for a vehicle according to an embodiment of the present invention.

Referring to FIG. 9, the processor 270 may acquire driver information (S910).

The processor 270 may acquire driver information for the authenticated driver, after authenticating the driver through the driver detection unit 219.

Here, the driver information may include traveling history information of the driver.

The processor 270 may determine the driver level of the driver based on the driver information (S920).

The processor 270 may determine the driver type of the driver based on the driver information (S920).

The processor 270 may receive the traveling state information (S930).

The processor 270 may acquire the traveling state information, based on at least one of object information outside the vehicle, navigation information, and vehicle state information.

The processor 270 may select the traveling function, based on the driving level of the driver (S940).

The processor 270 may select the traveling function based on the driver type of the driver (S940).

The processor 270 may select the traveling function, based on the traveling state information (S940).

The processor 270 may select the traveling function, based on a combination of two or more of the driving level, the driver type, and the traveling state information (S940).

The processor 270 may control to output the information on the selected traveling function through the output unit 250 (S950).

Here, the outputted traveling function may be referred to as a recommended traveling function.

In the state in which the recommended traveling function is outputted, the processor 270 may receive the user input (S960).

For example, the processor 270 may receive the user input through at least any one scheme of a voice input, a gesture input, a touch input, and a mechanical input.

When a user input is received, the processor 270 may provide a control signal to the vehicle drive device 600 so that the vehicle 100 can travel, based on the selected traveling function corresponding to the user input (S970).

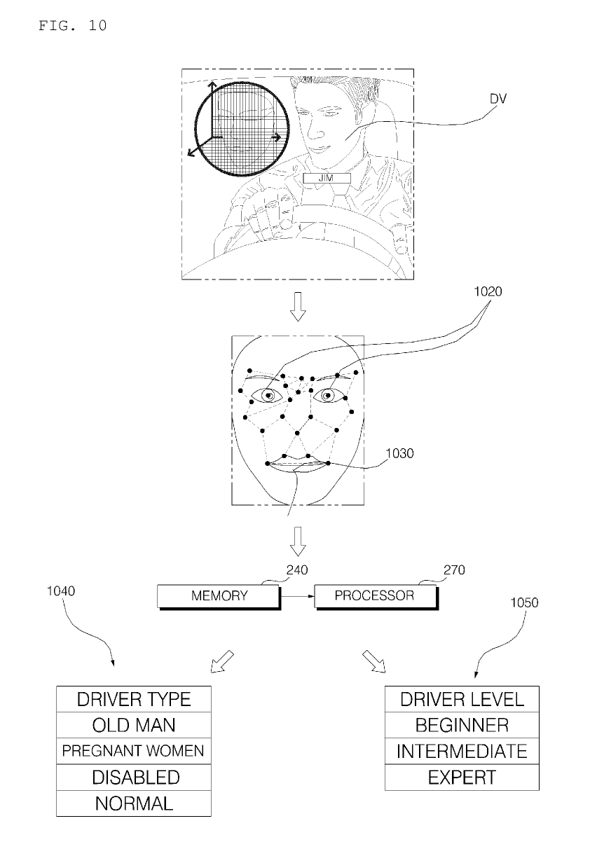

FIG. 10 is a diagram illustrating an operation of determining the driving level of driver or the driver type, based on driver information according to an embodiment of the present invention.

Referring to FIG. 10, the internal camera 220 may acquire a face image of the driver DV.

The processor 270 may compare the face image of the driver DV acquired by the internal camera 220 with the reference image information stored in the memory 240 to perform the driver authentication.

For example, the processor 270 may compare the acquired image with the reference image, based on the feature point, such as the distance between both eyes 1020 in the face image of the driver DV, the color of the pupil, the shape of the mouth 1030, the distance between the eyes 1020 and the mouth 1030, thereby performing the driver authentication

The processor 270 may receive the driver information of the authenticated driver from the memory 240.

The driver information may include the accumulated traveling history information stored in the memory 240 after the initial registration of the driver.

The processor 270 may determine the driver level 1050 of the driver, based on the driver information.

For example, the processor 270 may determine the driver level 1050 of the driver as one of a beginner, an intermediate, and an expert, based on the driver information.

The processor 270 may determine the driver type 1040 of the driver, based on the driver information.

For example, the processor 270 may determine the driver type 1050 as one of an old man, a pregnant woman, a disabled, and a normal person, based on the driver information.

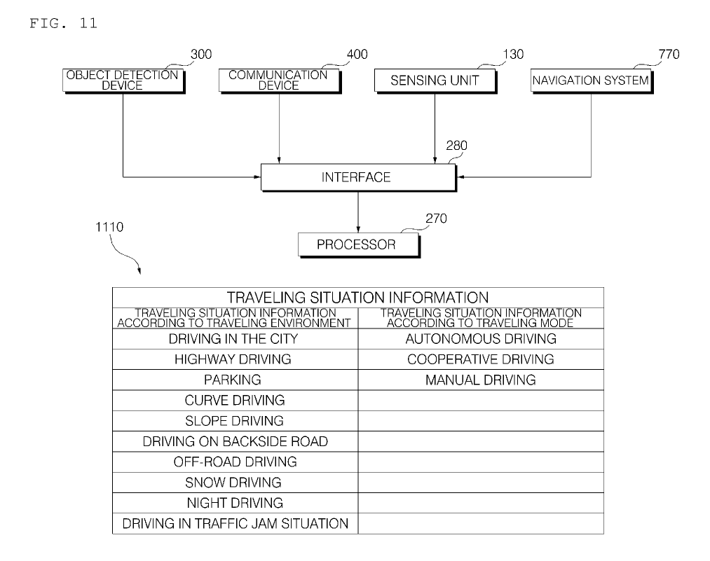

FIG. 11 is a diagram illustrating an operation of acquiring traveling state information according to an embodiment of the present invention.

Referring to FIG. 11, the processor 270 may determine the traveling state of the vehicle 100.

The processor 270 may receive the object information from the object detection device 300 via the interface 280.

The processor 270 may receive object information or navigation information from the communication device 400 via the interface 280.

The processor 270 may receive the vehicle state information from the sensing unit 130 via the interface 280.

The processor 270 may receive navigation information from the navigation system 770 via the interface 280.

The processor 270 may determine the traveling condition of the vehicle 100 based on at least one of the object information, the navigation information, and the vehicle state information.

According to an embodiment, the processor 270 may determine the traveling state of the vehicle 100 by classifying into the traveling state according to the traveling environment and the traveling state according to the traveling mode.

For example, the processor 270 may determine the traveling state according to the driving environment, as the traveling state in the city road, the traveling state in the highway, parking situation, the curve traveling state, the slope traveling state, the traveling state in the backside road, the traveling state in the off-road, the traveling state in the snow road, the traveling state in the night, the traveling state in the traffic jam, and the like.

For example, the processor 270 may determine the traveling state according to the traveling mode as an autonomous traveling state, a cooperative traveling state, a manual traveling state, and the like.

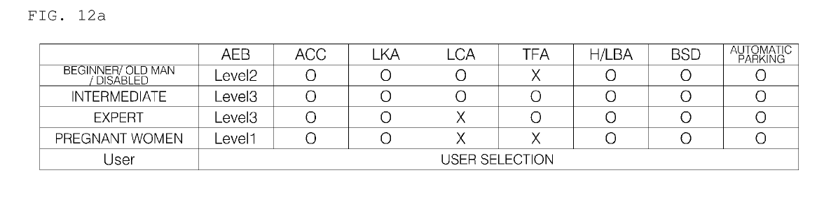

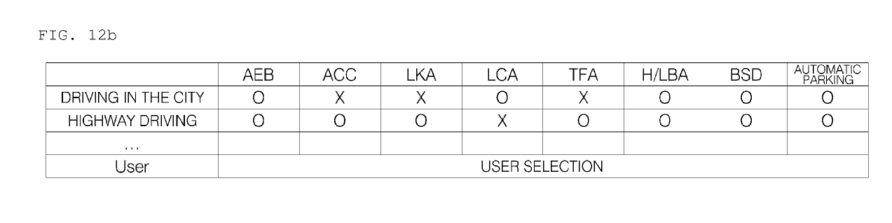

FIGS. 12A and 12B are diagrams illustrating examples of a traveling function selected based on a driving level, a driver type, or the traveling state information according to an embodiment of the present invention.

As illustrated in FIG. 12A, when it is determined that the driver is a beginner, an old man, or a disabled person, the processor 270 may select the second step AEB, ACC, LKA, LCA, HBA, LBA, BSD, and automatic parking.

If the driver is determined to be an intermediate driver, the third step AEB, ACC, LKA, LCA, HBA, LBA, BSD, and automatic parking may be selected as the traveling function.

If the driver is determined to be an expert, the third step AEB, ACC, LKA, LCA, HBA, LBA, BSD, and automatic parking may be selected as the traveling function.

If the driver is determined to be a pregnant woman, the first step AEB, ACC, LKA, LCA, HBA, LBA, BSD, and automatic parking may be selected as the traveling function.

As illustrated in FIG. 12B, when it is determined that the vehicle is traveling in a city road, the processor 270 may select AEB, LCA, HBA, LBA, BSD, and automatic parking as the traveling function

When it is determined that the vehicle is traveling in a highway, the processor 270 may select AEB, ACC, LKA, TFA, HBA, LBA, BSD, and automatic parking as the traveling function.

Meanwhile, according to an embodiment, the processor 270 may receive a user input through the input unit 210, and select all or some of the plurality of traveling functions according to the user input.

Meanwhile, the selection operation of the traveling function described with reference to FIGS. 12A and 12B is merely an illustrative description, and it will be readily apparent to those skilled in the art that other selections other than the exemplified contents are possible.

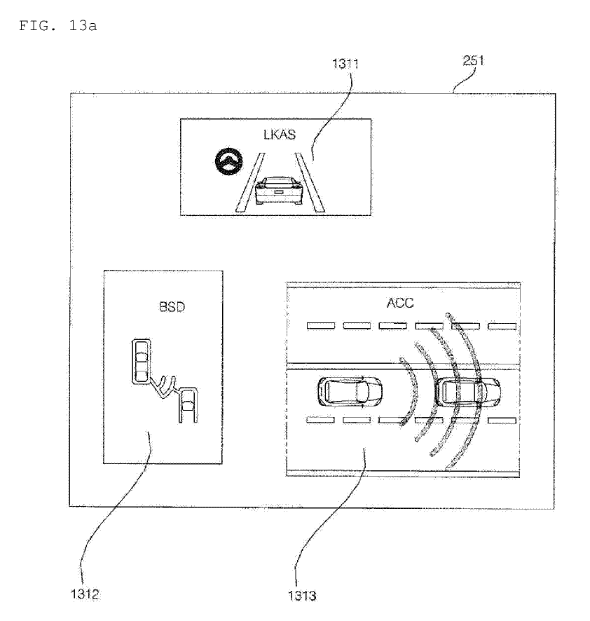

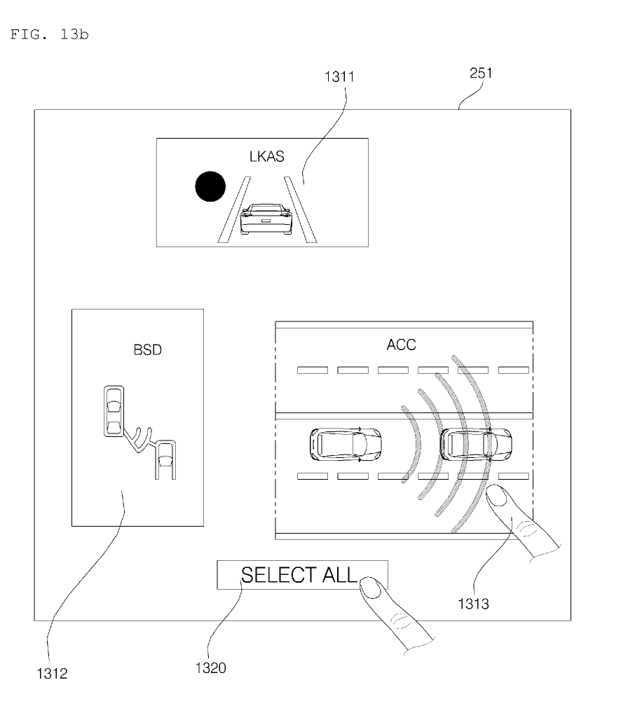

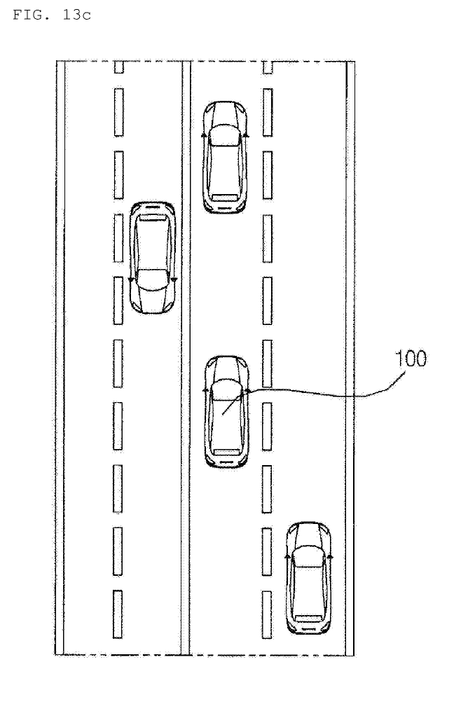

FIGS. 13A to 13C are diagrams illustrating the operation of a vehicle that outputs information on the traveling function and travels according to the traveling function according to an embodiment of the present invention.

Referring to FIG. 13A, the processor 270 may output selected traveling function information 1311, 1312, and 1313 to the display unit 251.

According to an embodiment, the processor 270 may output the image 1311, 1312, 1313 or text corresponding to the selected traveling function to the display unit 251.

Here, the image 1311, 1312, 1313 may be a still image or a moving image.

According to an embodiment, the processor 270 may output traveling function information by voice through the sound output unit 252.

Referring to FIG. 13B, in a state in which information on the selected traveling function is outputted, the processor 270 may receive user input through the input unit 210.

The processor 270 may receive user input that allows only some of a plurality of selected traveling functions to be performed.

The processor 270 may receive user input that allows all of a plurality of selected traveling functions to be performed.

The processor 270 may receive user input through at least one of the voice input unit 211, the gesture input unit 212, the touch input unit 213, and the mechanical input unit 214.

Referring to FIG. 13C, the processor 270 may provide a control signal to the vehicle drive apparatus 100 so that a traveling function corresponding to the user input can be implemented.

The vehicle 100 may travel according to the selected traveling function or the traveling function corresponding to the user input.

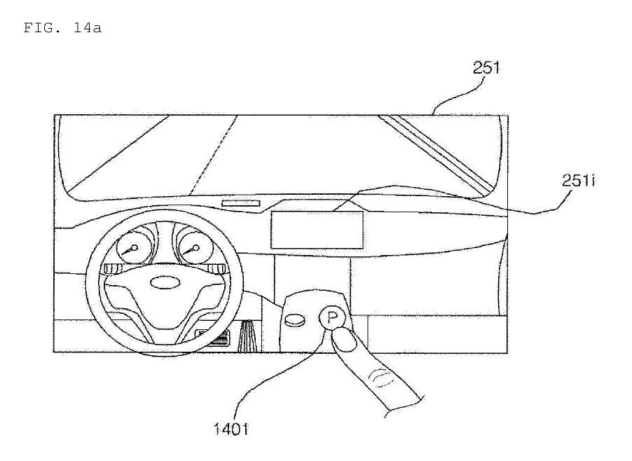

FIGS. 14A and 14B are diagrams illustrating an operation of outputting a tutorial image according to an embodiment of the present invention.

The processor 270 may control to output the tutorial image through the output unit 250.

Here, the tutorial image may be an image explaining the traveling function tridimensionally.

The user may check the manipulation method of various traveling functions of the vehicle and the operation of the vehicle according to the manipulation of traveling function, while watching the tutorial image.

An operation of outputting a tutorial image of automatic parking will be described with reference to FIGS. 14A and 14B.

As illustrated in FIG. 14A, the processor 270 may output the manipulation method of the traveling function through the tutorial image.

Specifically, the processor 270 may display the method of inputting an automatic parking function execution button 1401 through the display unit 251. The processor 270 may display an image depressing the automatic parking function execution button 1401, while displaying an in-vehicle image.

Thereafter, as illustrated in FIG. 14B, the processor 270 may display, through the display unit 251, an operation demonstration image of the vehicle 100 according to the execution of automatic parking function.

In this case, the processor 270 may display the continuous motion of the vehicle 100 as moving image. Alternatively, the processor 270 may display the operation of the vehicle 100 in several separate screens.

FIG. 14B illustrates the case of right angle parking.

Meanwhile, the processor 270 may output a tutorial image corresponding to the traveling function, before traveling, after the vehicle is turned on.

Meanwhile, the processor 270 may output a tutorial image corresponding to the selected traveling function, in a state in which the traveling function selected, based on the driving level, the driver type, or the traveling state information.

Meanwhile, the processor 270 may output a tutorial image corresponding to the selected traveling function based on the traveling state information during the autonomous traveling.

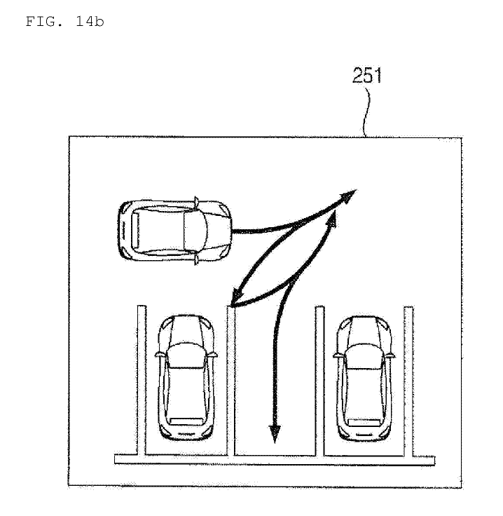

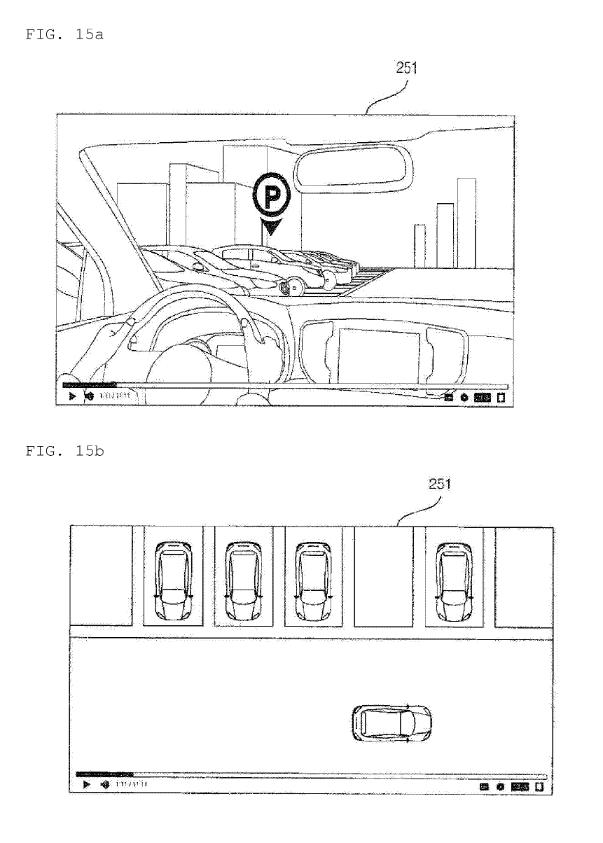

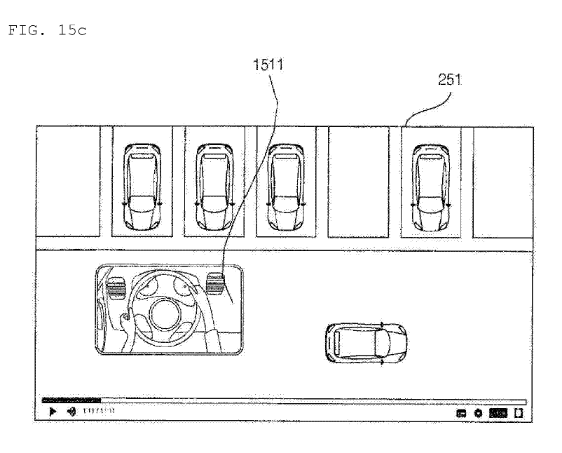

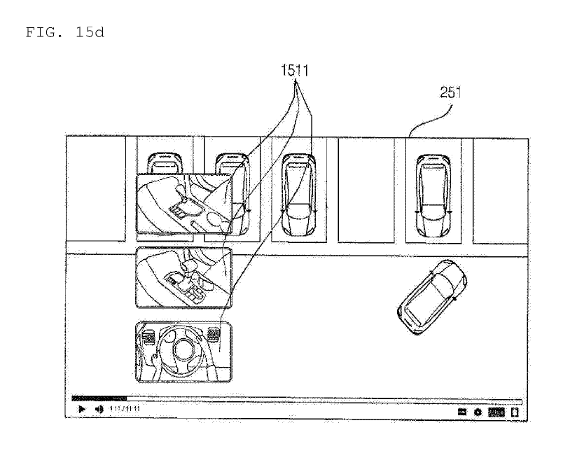

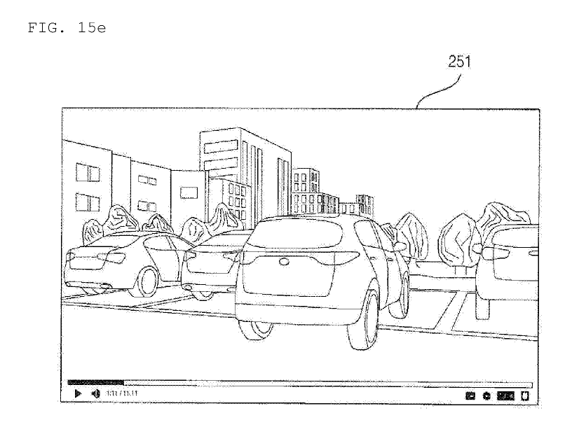

FIGS. 15A to 15E are diagrams illustrating an operation of outputting a simulation image, according to an embodiment of the present invention.

Referring to the drawing, the processor 270 may output the simulation image through the display unit 251. In this case, the simulation image may be outputted through the HUD.

By outputting the simulation image through the HUD, the driver may recognize the traveling function more easily.

The processor 270 may display the simulation image as a moving image. The processor 270 may display the simulation image as a plurality of separated images.

The processor 270 may generate the simulation image based on vehicle surrounding object information acquired by the object detection device 300.

For example, the processor 270 may generate a surrounding image based on an image around the vehicle acquired by the camera 310, and overlay a vehicle image corresponding to the vehicle 100 with the surrounding image, thereby generating a simulation image.

Meanwhile, the processor 270 may display a simulation image based on the driver's field of vision. FIG. 15A illustrates a simulation image based on the driver's field of vision,

Meanwhile, the processor 270 may display the simulation image as a top view. FIGS. 15B to 15D illustrate a simulation image of a top view.

Meanwhile, the processor 270 may display a simulation image as a front view, a side view, or a rear view. FIG. 15E illustrates a simulation image of the rear view.

FIGS. 15A to 15E illustrate a simulation image corresponding to a parking situation.

As illustrated in FIG. 15A, the processor 270 may display an image for searching for a parking space through the display unit 251.

Thereafter, as illustrated in FIG. 15B, the processor 270 may display, through the display unit 251, an image in which the vehicle 100 stops at a certain point while being spaced apart from the searched parking space by a certain distance.

Thereafter, as illustrated in FIGS. 15C to 15E, the processor 270 may display, through the display unit 251, an image of the vehicle 100 that is parking in the parking space.

At this time, the processor 270 may display guide information 1511 of the driving manipulation device 500 corresponding to the parking simulation image through the display unit 251.

As illustrated in FIGS. 15C and 15D, the processor 270 may output manipulation guide information of the steering input device 510. The processor 270 may output manipulation guide information of a t manipulation device. The processor 270 may output manipulation guide information of the acceleration input device 530 or the brake input device 570.

The processor 270 may display the guide information 1511 of the driving manipulation device 500 in one area of the display unit 251 at a point of time when a driving operation is required, among the parking simulation images.

The driver may operate the driving manipulation device 500 according to the guide information 1511 of the driving manipulation device 500.

The driving manipulation device 500 may generate a signal according to the manipulation of the driver.

In a state in which a simulation image is displayed, when a signal generated in the driving manipulation device 500 is received, the processor 270 may control the graphic objects in the simulation image to move in response to the signal.

At this time, the vehicle drive device 600 may not operate in response to a signal generated by the driving manipulation device 500.

For example, as illustrated in FIG. 15A, when the simulation image is displayed based on the driver's field of vision, the driver may try to simulate the vehicle traveling in such a manner that the driver actually drives while looking at the HUD.

For example, as illustrated in FIGS. 15B to 15D, when the simulation image is displayed as a top view, the driver may try to simulate the vehicle traveling while clearly recognizing the surrounding situation.

For example, as illustrated in FIG. 15E, when the simulation image is displayed as a front view, a side view, or a rear view, the driver may try to simulate the vehicle traveling while feeling a three-dimensional effect around the vehicle.

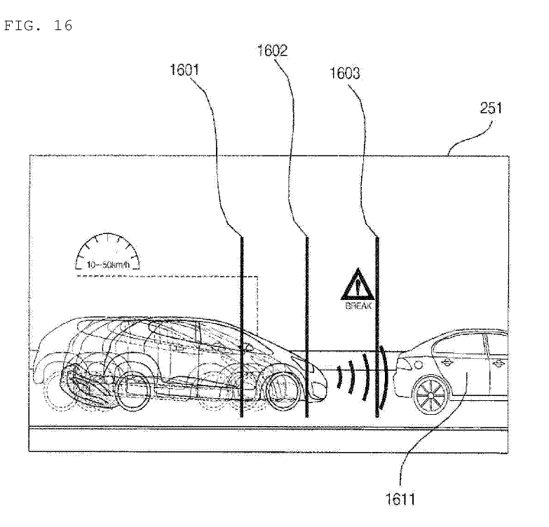

FIG. 16 is a diagram illustrating an operation of outputting a plurality of step information set in the traveling function according to an embodiment of the present invention.

Referring to FIG. 16, the processor 270 may output information on a plurality of steps of the AEB through the display unit 251.

For example, when the vehicle 100 is operated (1601) by the AEB of a first step, the processor 270 may output the motion image of the vehicle that stops at a distance of 3 m from the object 1611.

For example, when the vehicle 100 is operated by the AEB of a second step (1602), the processor 270 may output an operation image of the vehicle that stops at a distance of 2 m from the object 1611.

For example, when the vehicle 100 is operated by the AEB of a third step (1603), the processor 270 may output an operation image of the vehicle that stops at a distance of 1 m from the object 1611.

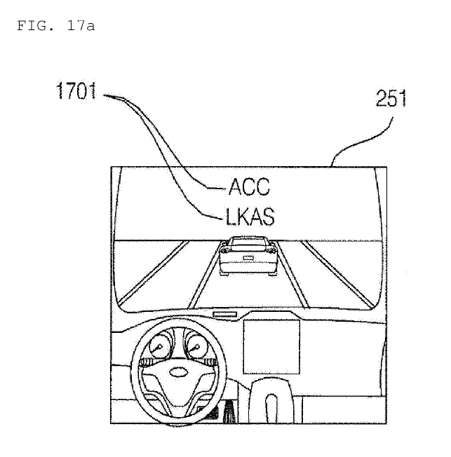

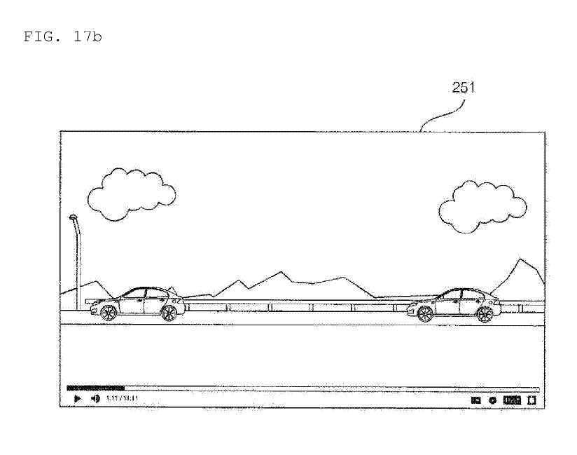

FIGS. 17A and 17B are diagrams illustrating an operation of outputting a traveling image according to an embodiment of the present invention.

Referring to the drawing, the processor 270 may output a traveling image through the display unit 251.

The traveling image may be a driver's visual field-based image, as illustrated in FIG. 17A.

Alternatively, the traveling image may be an image of a forward view, a side view, or a rear view, as illustrated in FIG. 17B.

Alternatively, the traveling image may be a top view image.

The processor 270 may output the traveling function information 1701 utilized at the time when the traveling image is photographed while the traveling image is being outputted.

Alternatively, the processor 270 may output the selected traveling function information 1701 while the traveling image is being outputted.

For example, as illustrated in FIG. 17A, the processor 270 may output the ACC and LKAS information to the display unit 251 while the traveling image is being outputted. In this case, the processor 270 may output an image or text corresponding to the ACC information and the LKAS respectively.

The processor 270 may receive a user input for the traveling function information 1701 outputted together with the traveling image. In this case, the processor 270 may output the information on the traveling function corresponding to the user input through the output unit 250. The processor 270 may provide a control signal to the vehicle drive device 600 so that the vehicle 100 can travel based on the traveling function corresponding to the user input.

Meanwhile, the traveling image may be an image photographed by the camera 310 of the vehicle 100. Alternatively, the traveling image may be an image photographed by a camera provided in other vehicle. The processor 270 may receive the traveling image from an external device of vehicle through the communication device 400.

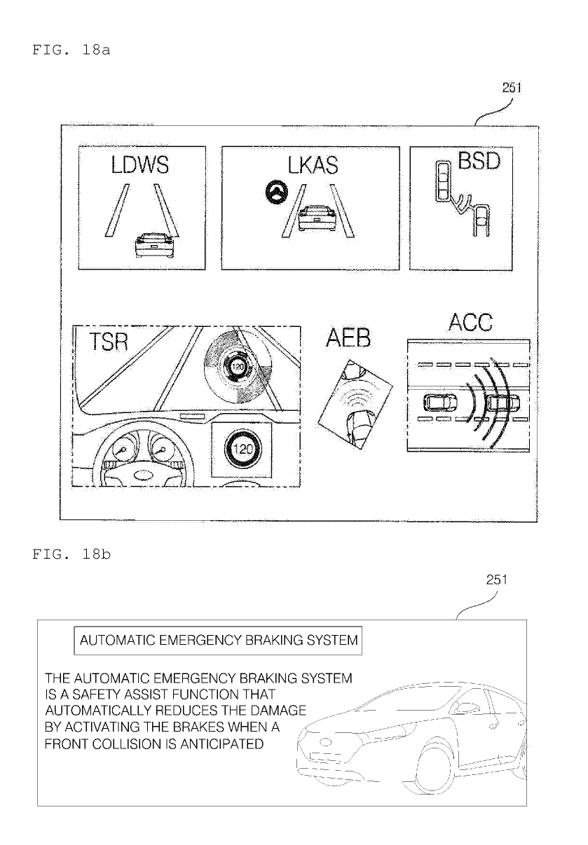

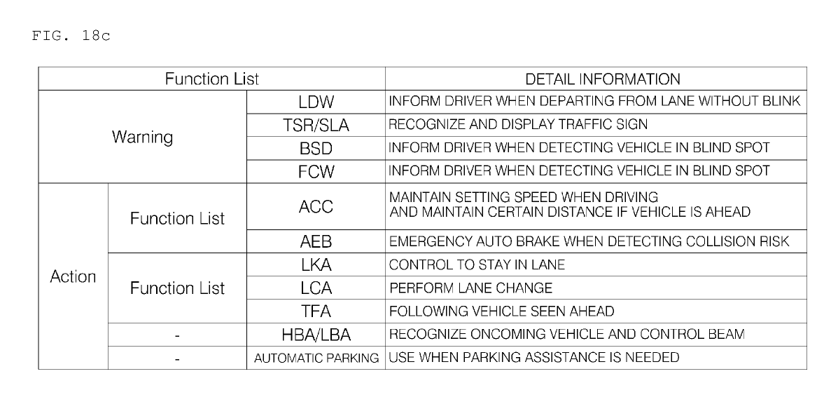

FIGS. 18A to 18C are diagrams illustrating the operation of outputting information on the traveling function according to an embodiment of the present invention.

Referring to the drawing, the processor 270 may output information on a plurality of traveling functions through the display unit 251, after the vehicle is turned on, before driving the vehicle.

As illustrated in FIG. 18A, the processor 270 may display, on the display unit 251, icons corresponding to LDWS, LKAS, BSD, TSR, AEB, and ACC respectively.

When the AEB is selected by the user input from among the plurality of traveling functions, the processor 270 may display detailed information of the AEB on the display unit 251 as illustrated in FIG. 18B.

In this case, the processor 270 may output the above described tutorial image or simulation image.

FIG. 18C illustrates a description of each of the plurality of travel functions. The processor 270 may output detailed information on the traveling function selected by the user, as illustrated in AEB of FIG. 18B.

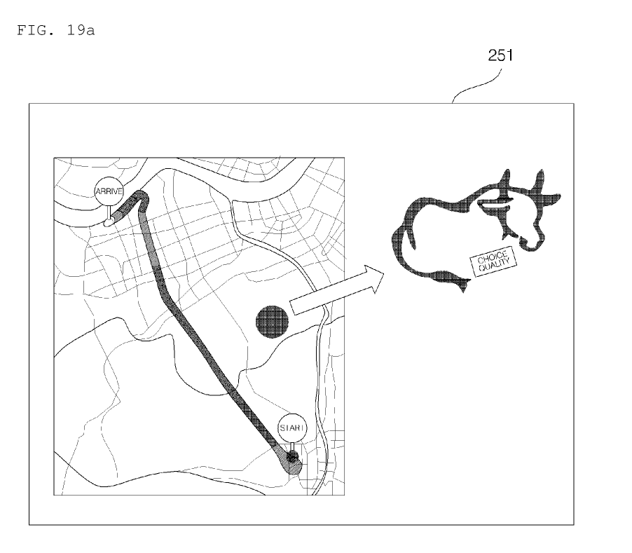

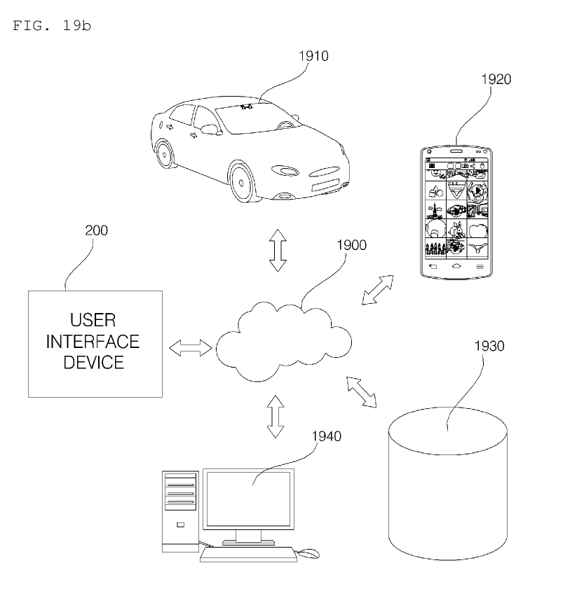

FIGS. 19A and 19B are diagrams illustrating the operation of setting a mission and achieving the mission according to an embodiment of the present invention.

Referring to FIG. 19A, the processor 270 may set a mission based on the driver level.

The processor 270 may set a mission to execute any one of the traveling functions, based on the driver level. For example, when the driver is determined to be a beginner, the processor 270 may set a mission that the driver selects and executes the ACC.

The processor 270 may set a mission of passing through a certain waypoint, based on the driver level. In this case, the processor 270 may set the waypoint based on the difficulty level of driving in a section formed up to the waypoint. For example, when it is determined that the driver is an intermediate driver, the processor 270 may set a mission of passing through a waypoint having a route corresponding to an intermediate course.

The execution of the mission may be determined by the user input.

When the mission is achieved, the processor 270 may provide a reward as the mission is achieved.

Referring to FIG. 19B, the processor 270 may share mission achievement information with the external device of vehicle, through the communication device 400.

Here, the external device of vehicle may include other vehicle 1910, a mobile terminal 1920, a server 1930, and a personal PC 1940.

For example, the processor 270 may transmit the mission achievement information to the Social Network Services (SNS) server 1930. In this case, the SNS server 1930 may generate content corresponding to the mission achievement information and provide the content to a preset SNS user.

Meanwhile, the reward information according to mission achievement may be provided from an external device.

The processor 270 may transmit the mission achievement information to the server 1930 of the vehicle manufacturer or the server 1930 of the traffic system operator. The server 1930 of the vehicle manufacturer or the server 1930 of the traffic system operator may evaluate the driver based on the mission achievement information, and generate and provide ranking information. At this time, the server 1930 of the vehicle manufacturer or the server 1930 of the traffic system operator may provide reward information and ranking information corresponding to the mission achievement information.

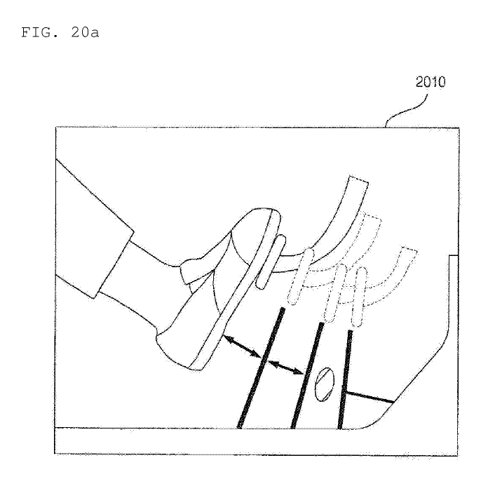

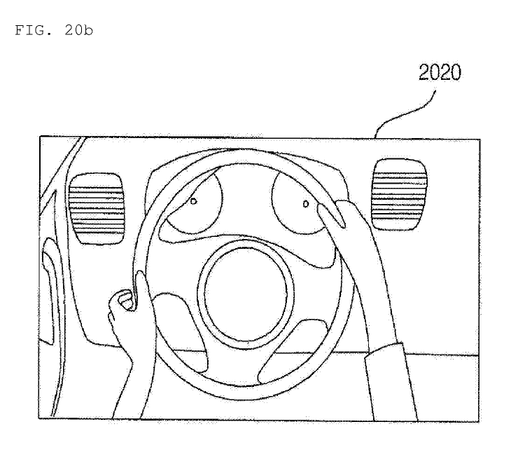

FIGS. 20A and 20B are diagrams illustrating driver intervention according to an embodiment of the present invention.

Referring to the drawings, in a state in which the vehicle 100 travels according to the traveling function, the processor 270 may receive a signal generated from the driving manipulation device 500.

As illustrated in FIG. 20A, the processor 270 may receive a signal by a brake pedal operation. At this time, when the degree of stepping on the brake pedal is equal to or greater than a threshold value, the processor 270 may determine that the driver is in the driver intervention state.

As illustrated in FIG. 20B, the processor 270 may receive a signal caused by manipulating the steering wheel. At this time, when the degree of rotation of the steering wheel is equal to or greater than the threshold value, the processor 270 may determine that it is in the driver intervention state.

The processor 270 may provide a control signal to stop the traveling of the vehicle 100 according to the traveling function, when it is determined that the vehicle is in the driver intervention state.

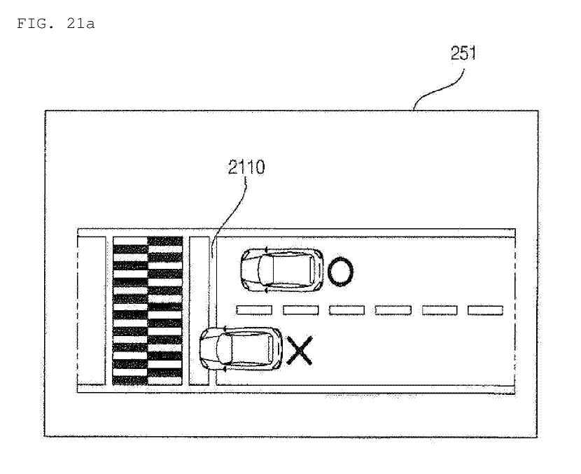

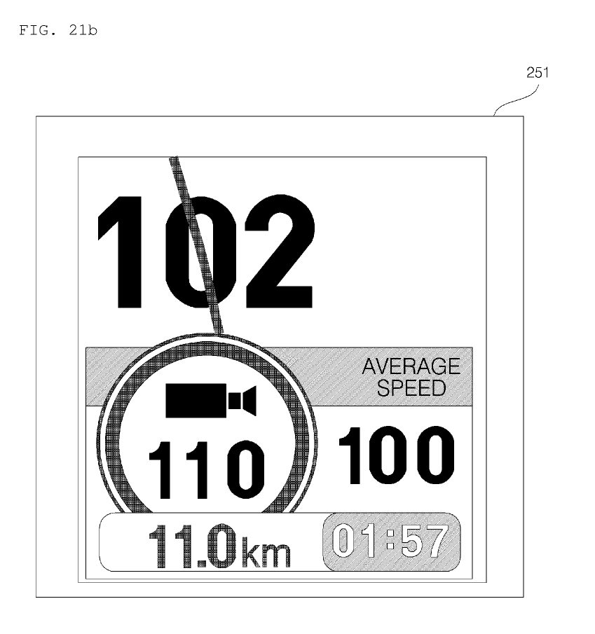

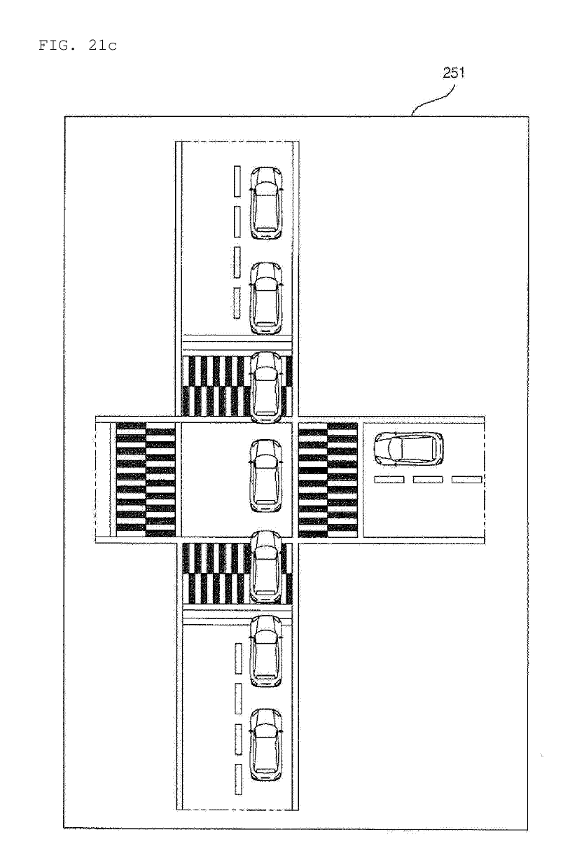

FIGS. 21A to 21C are diagrams illustrating the operation of a user interface apparatus for a vehicle for correcting driving habit according to an embodiment of the present invention.

FIGS. 21A to 21C are described on the assumption that the vehicle is in a manual traveling condition by a driver.

Referring to FIG. 21A, the processor 270 may acquire information on a stop line 2110 through the object detection device 300.

The processor 270 may determine a state where the vehicle 100 stops beyond the stop line 2110 based on the information acquired by the object detection device 300.

In this case, the processor 270 may output state information of stopping beyond the stop line 2110. The processor 270 may output guidance information for guiding the vehicle 100 to stop so as not to exceed the stop line 2110, together with the state information.

Referring to FIG. 21B, the processor 270 may determine a speed limit violation state through the sensing unit 120.

In this case, the processor 270 may output speed limit violation state information. In addition, the processor 270 may output guide information for guiding not to violate the speed limit, together with the speed limit violation state information.

Referring to FIG. 21C, the processor 270 may acquire information on a state where vehicle enters an intersection, at the time when the traffic light changes from green to red, through the object detection device 300.

In this case, the processor 270 may output the situation information. In addition, together with the situation information, the processor 270 may output guide information for guiding the vehicle not to enter the intersection when the traffic light is changed.

The present invention described above can be implemented as computer readable codes on a medium on which a program is recorded. The computer readable medium includes all kinds of recording apparatuses in which data that can be read by a computer system is stored. Examples of the computer readable medium include a hard disk drive (HDD), a solid state disk (SSD), a silicon disk drive (SDD), a ROM, a RAM, a CD-ROM, a magnetic tape, a floppy disk, and may also be implemented in the form of a carrier wave (e.g., transmission over the Internet). In addition, the computer may include a processor or a controller. Accordingly, the above detailed description is to be considered in all respects as illustrative and not restrictive. The scope of the present invention should be determined by rational interpretation of the appended claims, and all changes within the scope of equivalents of the present invention are included in the scope of the present invention.

1. A user interface apparatus for vehicle, the apparatus comprising:
an output unit;
a driver sensing unit; and
a processor configured to determine a driving level of a driver, based on driver information acquired through the driver sensing unit, select a traveling function based on the driving level of the driver among a plurality of traveling functions, and control to output information on the selected traveling function through the output unit.

2. The apparatus of claim 1, wherein the processor provides a control signal so that the vehicle travels, based on the selected traveling function.

3. The apparatus of claim 2, further comprising an input unit,
wherein the processor provides a control signal so that the vehicle travels, based on the selected traveling function, when a user input is received via the input unit in a state in which information on the selected traveling function is outputted.

4. The apparatus of claim 1, wherein the processor determines a driver type of the driver based on the driver information, and selects a traveling function based on the driver type.

5. The apparatus of claim 1, wherein the processor determines a traveling state of a vehicle, and selects the traveling function based on information on the traveling state.

6. The apparatus of claim 5, wherein the information on the traveling state is generated based on at least one of object information outside the vehicle, navigation information, and vehicle condition information.

7. The apparatus of claim 5, wherein the processor controls to output a tutorial image corresponding to the traveling state information through the output unit, wherein the tutorial image includes an operation demonstration image of the vehicle by the selected traveling function.

8. The apparatus of claim 7, wherein the processor controls to output operation information of the vehicle, when the vehicle is operated according to vehicle manipulation guide information and guide information through the tutorial image.

9. The apparatus of claim 7, wherein the tutorial image comprises a vehicle traveling simulation image.

10. The apparatus of claim 9, wherein the processor controls to output guidance information of a driving manipulation device corresponding to the simulation image is outputted through the output unit.

11. The apparatus of claim 10, further comprising an interface unit configured to exchange a signal with the driving manipulation device, wherein the processor controls graphic objects in the simulation image to move in response to a signal received from the driving manipulation device.

12. The apparatus of claim 1, further comprising a memory configured to store movement pattern information corresponding to a past movement route of the driver, wherein the processor selects the traveling function, based on the movement pattern information, when the vehicle travels in the movement route.

13. The apparatus of claim 1, wherein the processor selects any one step of the traveling functions set to a plurality of steps based on the level of the driver.

14. The apparatus of claim 13, wherein the processor controls the output unit to output information on a function provided for each of the plurality of steps.

15. The apparatus of claim 1, further comprising a memory configured to store a traveling image,
wherein the processor controls the output unit to output information on a traveling function corresponding to a user input, when the user input for any one of the plurality of traveling functions outputted through the traveling image is received, in a state in which the traveling image is outputted through the output unit.

16. The apparatus of claim 1, wherein the processor controls to output information on the plurality of traveling functions through the output unit, before the vehicle travels after the vehicle is turned on.

17. The apparatus of claim 1, further comprising an interface unit configured to receive route information from a navigation system,
wherein the processor sets a mission of passing through a waypoint corresponding to the driver level based on the route information, and controls to output information on the mission through the output unit.

18. The apparatus of claim 17, further comprising a communication device for exchanging data with a device outside the vehicle,
wherein the processor determines whether the mission is achieved based on whether the vehicle passes through the waypoint, and provides mission achievement information to the device when the mission is achieved.

19. The apparatus of claim 18, wherein the processor receives reward information corresponding to the mission achievement information from the device, and controls to output information on reward through the output unit.

20. A vehicle comprising:
the user interface apparatus for vehicle of claim 1; and
a vehicle drive device configured to drive at least one of a power source, a steering device, and a brake device, based on the selected traveling function.
